(19) United States
(12) Patent Application Publication
(10) Pub. No.: US 2026/0336566 A1
(43) Pub. Date: Oct. 29, 2026

(54) VEHICULAR CAMERA

(71) Applicant: Panasonic Automotive Systems Co., Ltd., Kanagawa (JP)

(72) Inventors: Shinichi NAGATA, Kanagawa (JP); Shinya OKADA, Aichi (JP); Hiroyuki TAHARA, Kanagawa (JP)

(73) Assignee: Panasonic Automotive Systems Co., Ltd., Kanagawa (JP)

(21) Appl. No.: 19/702,193

(22) Filed: Jun. 9, 2026

Related U.S. Application Data
(63) Continuation of application No. PCT/JP2024/045990, filed on Dec. 25, 2024.

(30) Foreign Application Priority Data
Dec. 27, 2023 (JP) 2023-221717
Mar. 8, 2024 (JP) 2024-035752
Dec. 13, 2024 (JP) 2024-218774

(51) Int. Cl. B60S 1/02; G03B 17/12; G03B 17/55; H04N 23/51; H04N 23/54

(52) U.S. Cl. CPC B60S 1/026; G03B 17/12; G03B 17/55; H04N 23/51; H04N 23/54

(57) ABSTRACT

A vehicular camera includes a lens barrel; an imaging element; a circuit board; a housing accommodating the imaging element and the circuit board; a connector; a connector connection portion; a heater portion; a conductive wire portion; a conductive wire connection portion disposed on the circuit board; and a switch disposed on the circuit board and controlling a voltage or current supplied to the heater portion. The conductive wire portion has an intermediate portion extending from the one end portion connected to the heater portion toward the first surface of the circuit board, and passing between the end surface of the circuit board and the inner surface of the housing. The conductive wire portion supplies predetermined electric power to the heater portion via the connector, the connector connection portion, the switch, the conductive wire connection portion, and first and second conductive wires of the conductive wire portion.

### CROSS-REFERENCE TO RELATED APPLICATIONS

This is a continuation of International Application No. PCT/JP2024/045990 filed on Dec. 25, 2024, and claims priority from Japanese Patent Application No. 2023-221717filed on Dec. 27, 2023, Japanese Patent Application No. 2024-035752 filed on Mar. 8, 2024, and Japanese Patent Application No. 2024-218774 filed on Dec. 13, 2024, and the entire content of which is incorporated herein by reference.

### TECHNICAL FIELD

The present disclosure relates to a vehicular camera.

With demands for improvements in vehicle safety, introduction of autonomous driving functions and the like in recent years, development of vehicular cameras that are mounted on vehicles and capture the inside and outside of the vehicles has become active (for example, see Patent Literature 1).

### CITATION LIST

### Patent Literature

Patent Literature 1: JP2022-131077A
Patent Literature 2: WO 2015/045110A
Patent Literature 3: JP2024-017298A
Patent Literature 4: JP2006-314074A
Patent Literature 5: JP2023-181856A
Patent Literature 6: WO 2024/004821
Patent Literature 7: JP2022-158532A

### SUMMARY OF INVENTION

A demand level related to the safety, the autonomous driving function, and the like, which are required for a vehicle, continues to increase, and further improvement in performance and the like are also required for the vehicular camera.

The present disclosure relates to a technique for providing a new vehicular camera.

The present disclosure provides a vehicular camera including: a lens barrel having a first cylindrical portion along an optical axis, a first end portion, a second end portion opposite to the first end portion, and at least one lens disposed along the optical axis; an imaging element disposed on the optical axis and closer to the second end portion than to the first end portion of the first cylindrical portion of the lens barrel; a circuit board including a first surface, a second surface opposite to the first surface, and an end surface connecting the first surface to the second surface, the imaging element being disposed on the first surface; a housing accommodating at least the imaging element and the circuit board, the housing having a second cylindrical portion, a third end portion, a fourth end portion disposed farther away from the first end portion of the first cylindrical portion of the lens barrel than the third end portion, an inner surface, and an outer surface; a connector that outputs an image signal from the imaging element to the outside, having at least a part disposed on the fourth end portion of the second cylindrical portion of the housing, including a first connector end portion and a second connector end portion opposite to the first connector end portion, the first connector end portion being electrically connected to the circuit board; a connector connection portion that is disposed on the circuit board and to which the first connector end portion of the connector is connected; a heater portion disposed at the first end portion of the first cylindrical portion of the lens barrel and configured to heat the at least one lens; a conductive wire portion having one end portion connected to the heater portion and another end portion opposite to the one end portion; a conductive wire connection portion that is disposed on the circuit board, to which the other end portion of the conductive wire portion is connected, and that is electrically connected to the connector connection portion and the conductive wire portion; and a switch disposed on the circuit board, electrically connected to the connector connection portion and the conductive wire connection portion, and configured to increase or decrease a voltage or current to be supplied to the heater portion. The connector connection portion, the switch, and the conductive wire connection portion are disposed on the second surface of the circuit board opposite to the first surface on which the imaging element is disposed. The conductive wire portion has an intermediate portion between the one end portion and the other end portion, the intermediate portion of the conductive wire portion extends from the one end portion connected to the heater portion toward the first surface of the circuit board, and passes between the end surface of the circuit board and the inner surface of the second cylindrical portion of the housing, the conductive wire portion includes a first conductive wire and a second conductive wire, and the conductive wire portion supplies predetermined electric power to the heater portion via the connector, the connector connection portion, the switch, the conductive wire connection portion, and the first conductive wire and the second conductive wire of the conductive wire portion.

According to the present disclosure, since the members for supplying electric power to the heater portion for securing the field of view are collectively disposed on the second surface of the circuit board, electric power loss due to wiring resistance can be reduced, and power consumption can be suppressed.

### BRIEF DESCRIPTION OF DRAWINGS

FIG. 1 is an example of a vehicle, and is a top view of the vehicle on which vehicular cameras are mounted;

FIG. 2 is a block diagram illustrating a connection example of the vehicular cameras, a camera ECU, and a display that are provided in the vehicle illustrated in FIG. 1;

FIG. 3 is another example of the vehicle, and is a schematic diagram of a vehicle interior of the vehicle on which a vehicular camera is mounted;

FIG. 4 is a top view of the vehicle in FIG. 3;

FIG. 5 is a block diagram illustrating a connection example of the vehicular cameras, the camera ECU, and the display device that are provided in the vehicle illustrated in FIG. 3;

FIG. 6 is a front perspective view of the vehicular camera according to an embodiment;

FIG. 7 is an exploded perspective view of the vehicular camera according to the embodiment;

FIG. 8 is a top view of the vehicular camera according to the embodiment;

FIG. 9 is a cross-sectional view taken along a line I-I in FIG. 8;

FIG. 10 is a side view of the vehicular camera according to the embodiment;

FIG. 11 is a cross-sectional view taken along a line II-II in FIG. 10;

FIG. 12A is a perspective view of a lens barrel viewed from below;

FIG. 12B is a bottom view of the lens barrel;

FIG. 13A is a perspective view of a state in which a strip-shaped flexible conductive wire is added to FIG. 12A;

FIG. 13B is a perspective view of a state in which the strip-shaped flexible conductive wire is added to FIG. 12B;

FIG. 14A is a perspective view of a state in which a front shield is added to FIG. 12A;

FIG. 14B is a perspective view of a state in which the front shield is added to FIG. 12B;

FIG. 15A is a perspective view of a state in which a strip-shaped flexible conductive wire and the front shield are added to FIG. 12A;

FIG. 15B is a perspective view of a state in which the strip-shaped flexible conductive wire and the front shield are added to FIG. 12B;

FIG. 16 is a circuit diagram of the vehicular camera and the vehicle;

FIG. 17 is a circuit diagram of a circuit board;

FIG. 18 is a plan view of a second surface of the circuit board;

FIG. 19 is a plan view of a heater portion and the strip-shaped flexible conductive wire in an unfolded state;

FIG. 20 is a plan view of a second surface of the circuit board different from the embodiment of FIG. 19; and

FIG. 21 is a cross-sectional view taken along a line III-III in FIG. 8.

### DESCRIPTION OF EMBODIMENTS

Hereinafter, an embodiment that specifically discloses a vehicular camera according to the present disclosure will be described in detail with reference to the drawings as appropriate. However, unnecessarily detailed descriptions may be omitted. For example, detailed descriptions of already well-known matters and redundant descriptions of substantially the same configuration may be omitted. This is to avoid unnecessary redundancy of the following descriptions and to facilitate understanding of those skilled in the art. It should be noted that the accompanying drawings and the following description are provided for those skilled in the art to sufficiently understand the present disclosure, and are not intended to limit the subject matter described in the claims.

### Vehicle on Which Vehicular Cameras are Mounted

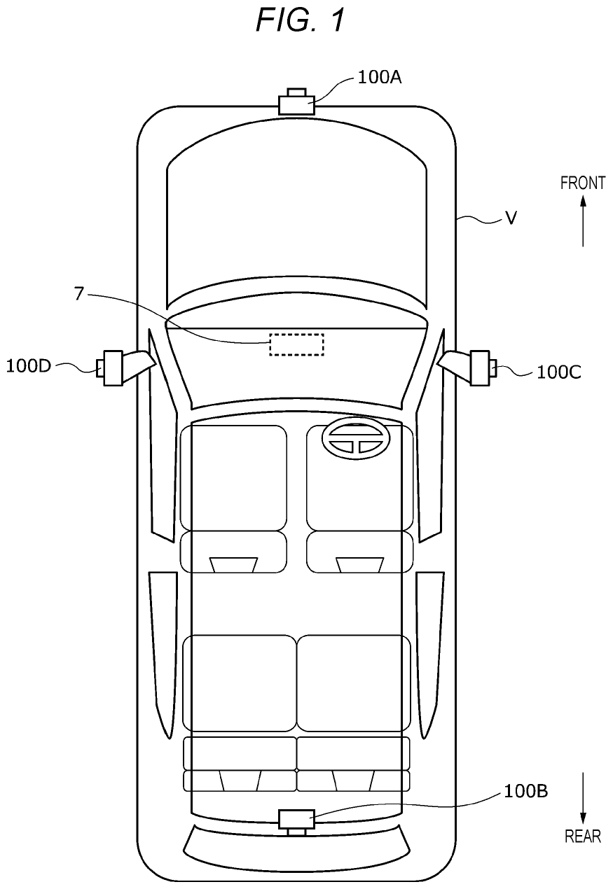

FIG. 1 is an example of a vehicle, and illustrates a top view of the vehicle on which vehicular cameras are mounted. As a vehicular camera 100, a vehicular camera 100A, a vehicular camera 100B, a vehicular camera 100C, and a vehicular camera 100D are mounted on a vehicle V. The vehicular camera 100A is a front camera, the vehicular camera 100B is a rear camera, the vehicular camera 100C is a right side camera, and the vehicular camera 100D is a left side camera. The vehicular cameras 100A to 100D are, for example, wide-angle cameras having an angle of view of about 180°, and are disposed to capture images of an entire periphery of the vehicle V.

For example, the vehicular camera 100A is provided in a front grille of the vehicle V, and captures an image of a front region in a direction of looking down obliquely with respect to the ground. The vehicular camera 100B is provided on a roof spoiler of the vehicle V, and captures an image of a rear region in a direction of looking down obliquely with respect to the ground. The vehicular camera 100C and the vehicular camera 100D are provided in side mirrors of the vehicle V, and capture images of lateral regions in directions of looking down obliquely with respect to the ground, respectively.

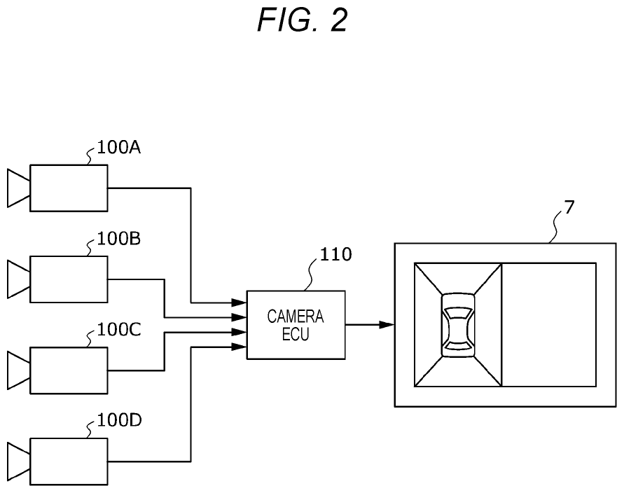

FIG. 2 is a block diagram illustrating a connection example of the vehicular cameras 100A to 100D, a camera ECU 111, and a display 7 that are provided in the vehicle V illustrated in FIG. 1. The camera electronic control unit (ECU) 111 in FIG. 2 synthesizes the images captured by the vehicular cameras 100A to 100D, and displays a synthesized image on, for example, the display 7 of a navigation system disposed on an instrument panel. An occupant can visually recognize the display 7 and check a situation around the vehicle V.

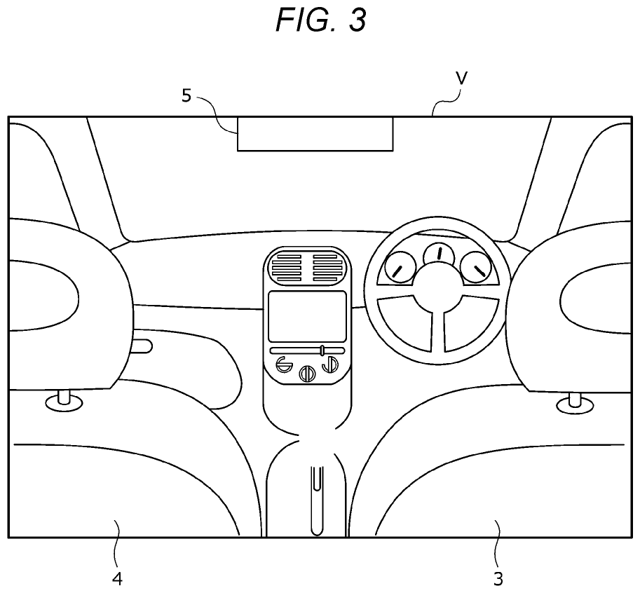

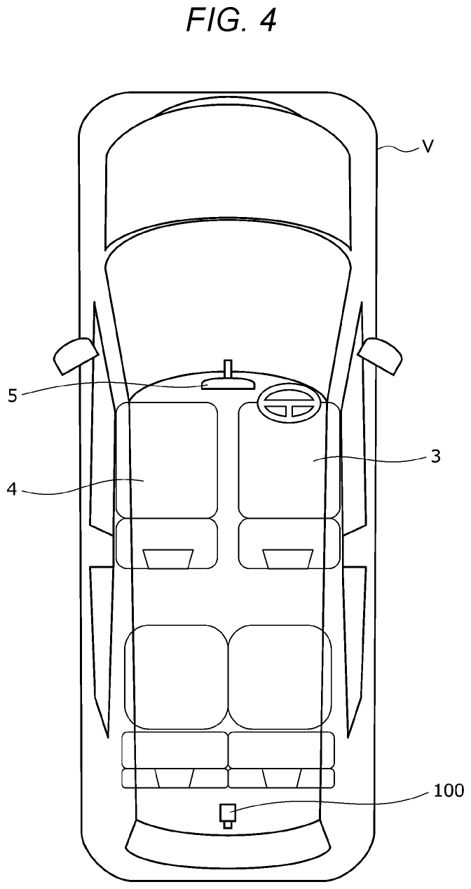

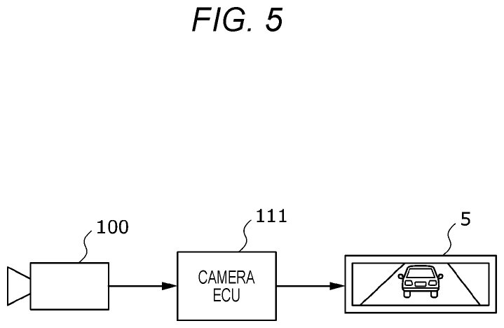

FIG. 3 is another example of the vehicle, and is a schematic diagram of a vehicle interior of the vehicle on which the vehicular camera is mounted, and FIG. 4 is a top view of the vehicle in FIG. 3. The vehicle V includes a display device 5 (for example, an electronic rearview mirror) at an attachment position of a rearview mirror, which is a front portion between a driver's seat 3 and a passenger seat 4 in a vehicle interior 2. Further, the vehicle V is provided with the vehicular camera 100 at a rear side of a vehicle body. FIG. 5 is a block diagram illustrating a connection example of the vehicular camera 100, a camera ECU 111, and the display device 5 that are provided in the vehicle V illustrated in FIG. 3. The camera electronic control unit (ECU) 111 in FIG. 5 processes an image captured by the vehicular camera 100, and the display device 5 displays the image. The occupant can visually recognize the display device 5 and check a rear situation of the vehicle V.

### Embodiment of Vehicular Camera

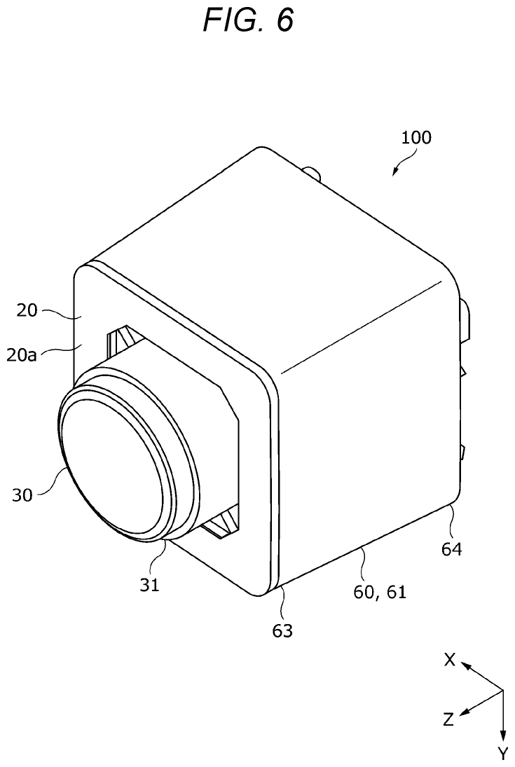

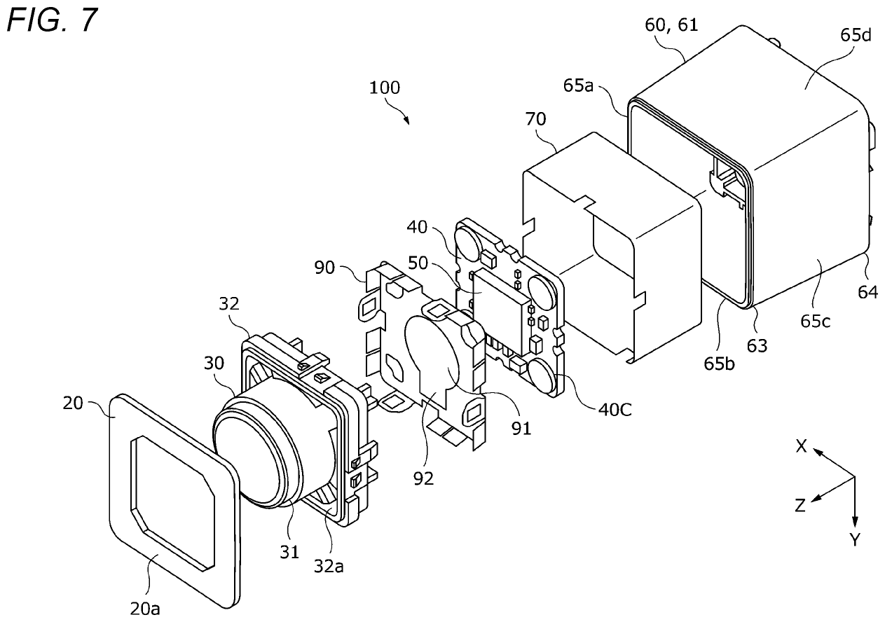

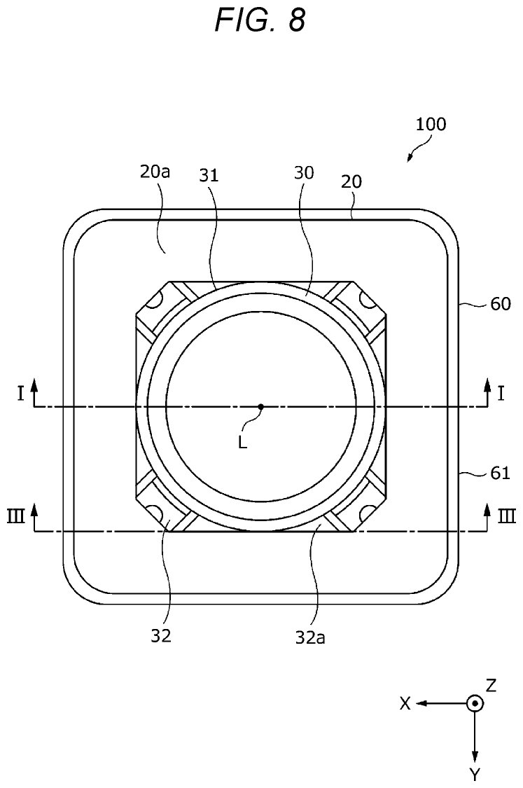

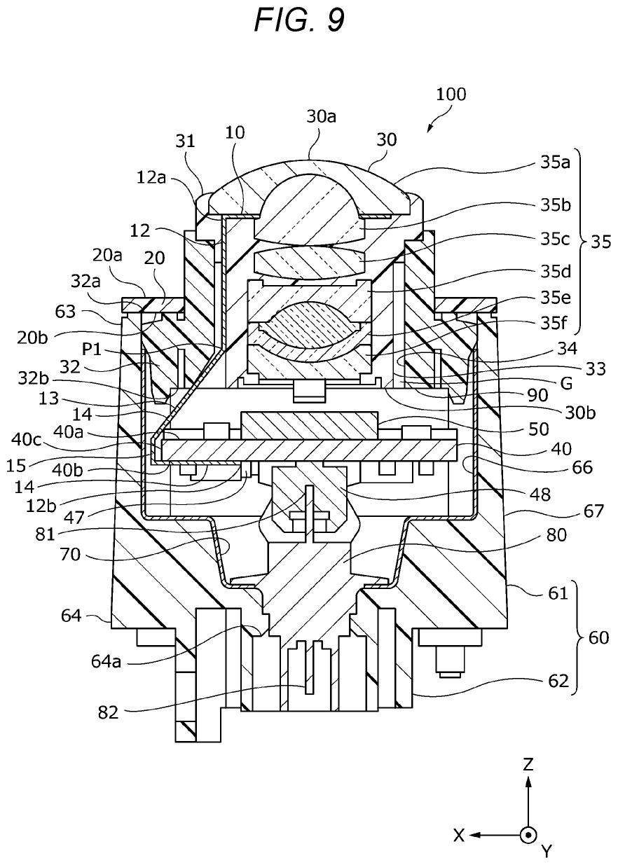

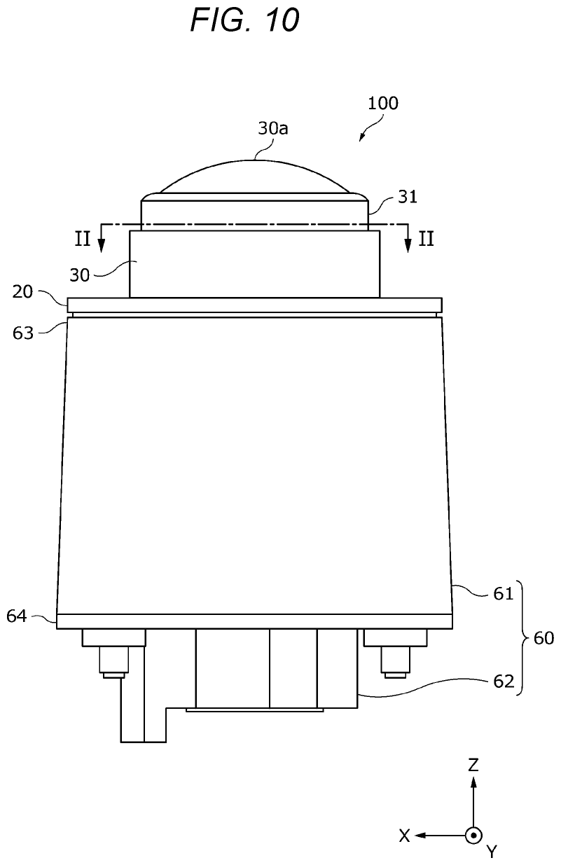

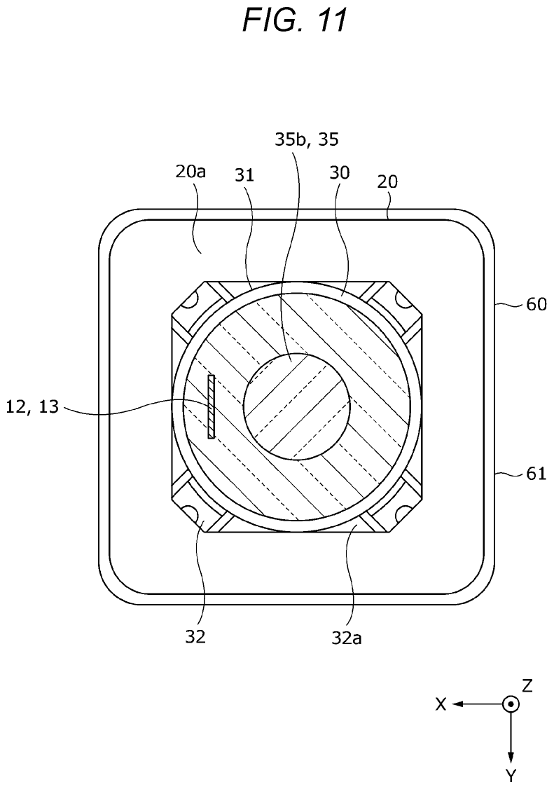

FIG. 6 is a front perspective view of the vehicular camera 100 according to an embodiment. FIG. 7 is an exploded perspective view of the vehicular camera 100 according to the embodiment. FIG. 8 is a top view of the vehicular camera 100 according to the embodiment. FIG. 9 is a cross-sectional view taken along a line I-I in FIG. 8. FIG. 10 is a side view of the vehicular camera 100 according to the embodiment. FIG. 11 is a cross-sectional view taken along a line II-II in FIG. 10. Coordinates including an X axis along one side of the vehicular camera 100, a Y axis orthogonal to the X axis and along another side of the vehicular camera 100, and a Z axis orthogonal to the X axis and the Y axis and along a height direction of the vehicular camera 100 are defined, and are used in the following description.

The vehicular camera 100 according to the present embodiment includes a ring member 20, a lens barrel 30, a circuit board 40, an imaging element 50, a housing 60, a rear shield 70, and a front shield 90.

The ring member 20 is implemented by a flat plate-shaped member including a first surface 20a and a second surface 20b opposite to the first surface 20a. The second surface 20b of the ring member 20 is welded to the lens barrel 30 and the housing 60 by laser welding. An inner peripheral surface of the ring member 20 faces an outer peripheral surface of a first cylindrical portion 31 (to be described below) of the lens barrel 30. An inner diameter of the ring member 20 has a length that allows the first cylindrical portion 31 of the lens barrel 30 to be inserted.

The ring member 20 can be formed of a first resin having predetermined light transmittance. Accordingly, the ring member 20 can be easily formed at low cost.

The lens barrel 30 includes a first cylindrical portion 31 having a first cylindrical shape. As illustrated in FIG. 9, the lens barrel 30 has an inner surface 33 and an outer surface 34, and has a first end portion 30a and a second end portion 30b opposite to the first end portion 30a in a direction along an optical axis L (a direction orthogonal to the paper surface of FIG. 8 and along the Z axis). The inner surface 33 corresponds to the outer peripheral surface of the first cylindrical portion 31, and has a cylindrical surface in the present embodiment. The outer surface 34 corresponds to an outer peripheral surface of a flange portion 32 to be described later, and has a cylindrical surface in the present embodiment. The inner surface 33 and the outer surface 34 face each other and form a gap of a predetermined distance in a radial direction. The first cylindrical portion 31 may be a separate body from the flange portion 32 and may be bonded thereto via an adhesive. The first cylindrical portion 31 may be formed integrally with the flange portion 32.

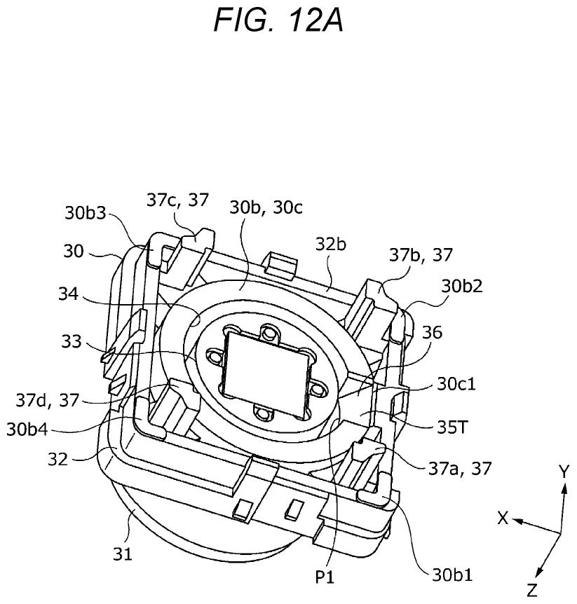

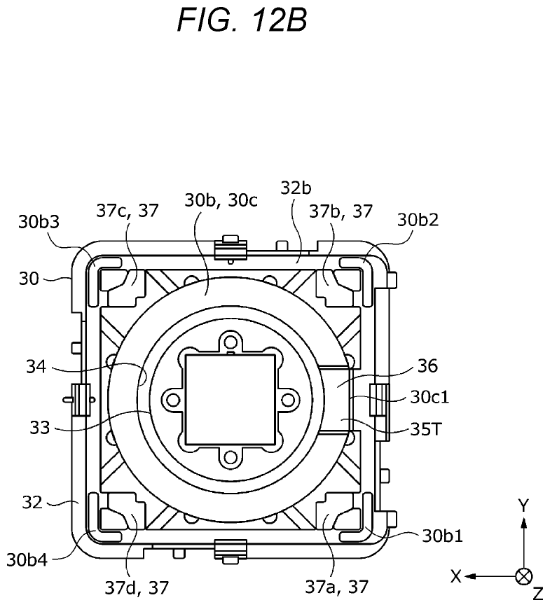

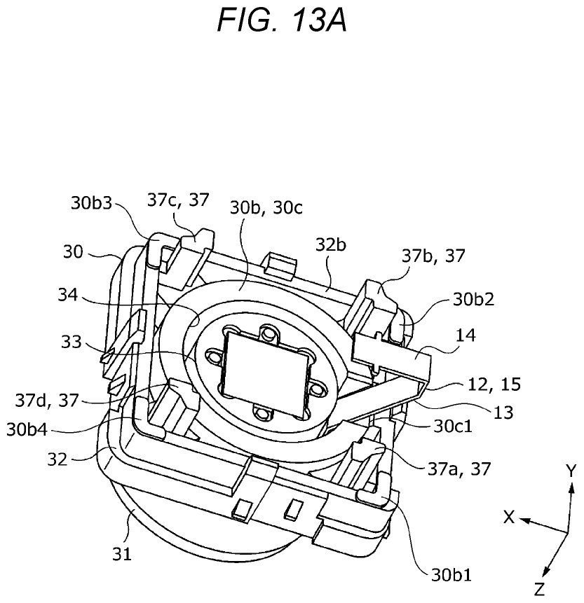

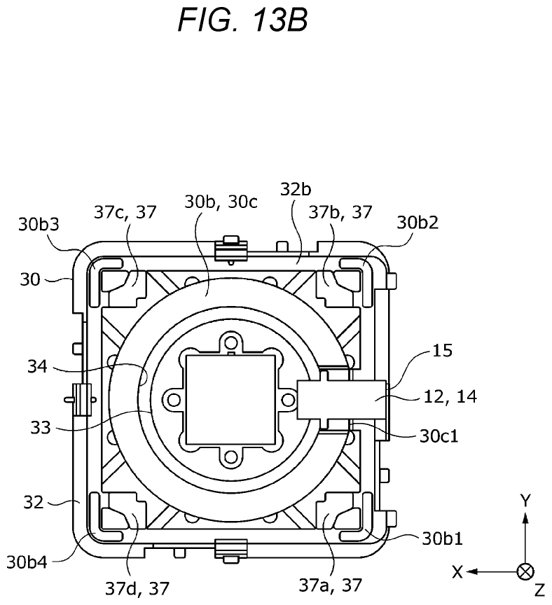

The first end portion 30a constitutes a distal end portion of the lens barrel 30, and the second end portion 30b has a lens barrel end surface 30c (see FIGS. 12A to 13B) at least partially facing the circuit board 40 inside the housing 60.

The lens barrel 30 includes, at a position radially inward of the inner surface 33, at least one lens 35 accommodated inside the first cylindrical portion 31 and disposed on the optical axis L. The first cylindrical portion 31 has a cylindrical shape, and holds therein, for example, a lens group including a plurality of lenses 35. The respective lenses 35 in the lens group are arranged adjacently in a state in which respective optical axes L are aligned with each other, and constitute the lens group used for capturing images of the inside and outside of the vehicle body of the vehicle V.

Further, the lens barrel 30 has, at the second end portion 30b, a flange portion 32 disposed to extend outward from the optical axis L as a reference over an entire circumference around the optical axis L. The flange portion 32 includes a first flange surface 32a facing at least a part of the second surface 20b of the ring member 20 and a second flange surface 32b opposite to the first flange surface 32a.

At least the second flange surface 32b of the lens barrel 30 can be formed of a second resin having a first light absorptivity. The lens barrel 30 may be entirely molded with the second resin. Accordingly, the lens barrel 30 can be easily molded at low cost.

The imaging element 50 is disposed in an internal space of the housing 60 on the optical axis L and closer to the second end portion 30b than to the first end portion 30a of the lens barrel 30. The imaging element 50 is electrically connected to a circuit of the circuit board 40, and the imaging element 50 can capture an image by directing external light to the imaging element 50. The imaging element 50 may be, for example, a complementary metal-oxide-semiconductor (CMOS) image sensor.

The circuit board 40 is disposed in the internal space of the housing 60, and includes a first surface 40a and a second surface 40b opposite to the first surface 40a. However, two or more circuit boards may be provided. The imaging element 50 is disposed on the first surface 40a of the circuit board 40.

The circuit board 40 has a first shape in a plan view. The first shape in the plan view is a shape when viewed in a direction from the first surface 40a toward the second surface 40b of the circuit board 40. The first shape is, for example, a first quadrangular shape as in the embodiment, but may be a polygonal shape having five or more sides. The corners of the polygon may be rounded. When the circuit board 40 has the first quadrangular shape, the circuit board 40 can be easily formed.

The housing 60 is a cylindrical member having the internal space, and serves to accommodate at least the circuit board 40 and the imaging element 50. The housing 60 includes a large-diameter cylindrical portion 61 having a second cylindrical shape along the optical axis L, a third end portion 63, and a fourth end portion 64. The third end portion 63 is connected to the lens barrel 30. The fourth end portion 64 is opposite to the third end portion 63 in a direction along the optical axis L, and is disposed farther away from the first end portion 30a of the first cylindrical portion 31 of the lens barrel 30 than the third end portion 63. The housing 60 includes an inner surface 66 facing the internal space of the second cylindrical shape and an outer surface 67 of the second cylindrical shape.

The housing 60 further includes a small-diameter cylindrical portion 62 that is formed continuously with the fourth end portion 64, protrudes in a direction away from the circuit board 40 in the direction along the optical axis L, and has a diameter smaller than a diameter of the large-diameter cylindrical portion 61. The large-diameter cylindrical portion 61 constitutes a second cylindrical portion, and the small-diameter cylindrical portion 62 constitutes a third cylindrical portion.

The large-diameter cylindrical portion 61 and the small-diameter cylindrical portion 62 may be integrally formed, and the large-diameter cylindrical portion 61 and the small-diameter cylindrical portion 62 prepared individually in advance may be bonded by a method such as welding or screwing. In the present embodiment, the housing 60 has a rectangular cylindrical shape, but is not limited thereto, and may have a polygonal cylindrical shape other than the rectangular cylindrical shape, a circular or elliptical cylindrical shape, or another cylindrical shape.

In a state in which the housing 60 accommodates at least the circuit board 40 and the imaging element 50, the ring member 20 is welded to the flange portion 32 of the lens barrel 30 on a radially inner side, and is welded to the third end portion 63 of the housing 60 on a radially outer side over the entire circumference. The welding is performed by, for example, laser welding.

General laser welding is used for welding, for example, the first resin having a predetermined light transmittance and the second resin or a third resin having a light transmittance lower than the light transmittance of the first resin at a wavelength of laser light. When the first resin is irradiated with the laser light in a state in which pressure is applied to both the resins, the laser light is not absorbed and passes through the first resin. The transmitted laser light is absorbed by a surface of the second resin or the third resin having a light transmittance lower than that of the first resin. The energy of the absorbed laser is converted into heat, and the surface of the second resin or the third resin is heated. Further, a surface of the first resin in contact with the surface of the second resin or the third resin is also heated due to heat conduction. Accordingly, at an interface between the first resin and the second resin or the third resin, both resins are melted. When the laser emission is stopped, the melted resin is solidified and both resins are welded.

The ring member 20 is formed of the first resin, and at least the second flange surface 32b of the flange portion 32 of the lens barrel 30 is formed of the second resin having the first light absorptivity. The first end portion 30a of the housing 60 is formed of the third resin having a second light absorptivity.

In the laser welding, first, in a state in which the second surface 20b of the ring member 20 is pressed against the first flange surface 32a of the flange portion 32 of the lens barrel 30, the laser is emitted to weld the second surface 20b of the ring member 20 and the first flange surface 32a. Thereafter, in a state in which the second surface 20b of the ring member 20 is pressed against the third end portion 63 of the housing 60, the laser is emitted to weld the second surface 20b of the ring member 20 and the third end portion 63. In addition, before the laser welding, four protruding portions 37 (see FIG. 12A and the like) of the lens barrel 30 to be described later may be fixed to the first surface 40a of the circuit board 40 via an adhesive in advance. In this case, it is necessary to accurately align the lens barrel 30 and the circuit board 40.

The rear shield 70 is a box-shaped conductive member accommodated inside the housing 60. The rear shield 70 is formed of a conductive metal or the like and serves to shield internal and external noise of the housing 60. The front shield 90 is a planar conductive member accommodated inside the housing 60. The front shield 90 is formed of a conductive metal or the like and serves to shield internal and external noise of the housing 60. Details of the front shield 90 will be described later.

The vehicular camera 100 of the embodiment further includes a heater portion 10 that is disposed at the first end portion 30a of the lens barrel 30 and generates heat by electric power. The heater portion 10 is a member for removing raindrops, freezing, and the like by heat generation and securing a field of view of the vehicular camera 100. The heater portion 10 may be formed of, for example, a positive temperature coefficient (PTC) heater. The PTC heater can perform self-temperature control. The heater portion 10 may be, for example, a metal heater.

The vehicular camera 100 of the embodiment further includes a strip-shaped flexible conductive wire 12 that has one end portion 12a connected to the heater portion 10 and the other end portion 12b opposite to the one end portion 12a connected to the circuit board 40 and serves as a conductive wire portion supplying electric power to the heater portion 10. The strip-shaped flexible conductive wire 12 may be formed of, for example, a flexible substrate using polyimide as a base material, and the strip-shaped flexible conductive wire 12 can be easily formed. However, the present invention is not limited thereto, and the strip-shaped flexible conductive wire 12 may have a strip shape, may be flexible, and may conduct electricity.

FIG. 10 is a side view of the vehicular camera 100 according to the embodiment, and FIG. 11 is a cross-sectional view taken along a line II-II in FIG. 10. As illustrated in FIG. 9, the lens 35 includes a first lens 35a, a second lens 35b, a third lens 35c, a fourth lens 35d, a fifth lens 35e, and a sixth lens 35f arranged adjacently along the optical axis L. FIG. 11 illustrates the second lens 35b and the strip-shaped flexible conductive wire 12 beside it.

As illustrated in FIG. 9, the strip-shaped flexible conductive wire 12 includes an intermediate portion 15 located between the one end portion 12a and the other end portion 12b, a first connection portion 13 connecting the one end portion 12a to the intermediate portion 15, and a second connection portion 14 connecting the intermediate portion 15 to the other end portion 12b. As will be described later, the strip-shaped flexible conductive wire 12 may include a plurality of conductive wires. As illustrated in FIGS. 9 and 11, since the strip-shaped flexible conductive wire 12, which is the conductive wire portion, has a linear shape, the strip-shaped flexible conductive wire 12 can be disposed at the shortest distance along the optical axis between the inner surface 33 and the outer surface 34 of the lens barrel 30.

The inner surface 33 of the lens barrel 30 has a second shape in a cross section orthogonal to the optical axis L (a cross section along the radial direction). In the embodiment, the second shape is a circular shape. Further, in the embodiment, the first shape of the circuit board 40 is a square, and a first width passing through a first center of the first shape corresponds to the length of one side of the square.

The first width passing through the first center of the first shape of the circuit board 40 is larger than a second width passing through a second center of the second shape of the cross section of the inner surface 33 of the lens barrel 30. That is, one side of the circuit board 40 is larger than the diameter of the circular shape, which is the second shape of the cross section of the inner surface 33 of the lens barrel 30.

FIG. 12A is a perspective view of the lens barrel 30 as viewed from below, and FIG. 12B is a bottom view of the lens barrel 30. FIG. 13A is a perspective view of a state in which the strip-shaped flexible conductive wire 12 is added to FIG. 12A, and FIG. 13B is a perspective view of a state in which the strip-shaped flexible conductive wire 12 is added to FIG. 12B. The lens barrel 30 includes a tapered surface 35T. The tapered surface 35T faces the optical axis L, is formed to move away from the optical axis L as it goes from a predetermined position P1 between the first end portion 30a and the second end portion 30b of the lens barrel 30 toward the second end portion 30b of the lens barrel 30, and is disposed along at least a part of the first connection portion 13 of the strip-shaped flexible conductive wire 12.

That is, the strip-shaped flexible conductive wire 12 is led out from between the inner surface 33 and the outer surface 34 of the lens barrel 30 toward the circuit board 40. The strip-shaped flexible conductive wire 12 is led out from the lens barrel 30 from the predetermined position P1 so as to be guided radially outward along the tapered surface 35T.

Accordingly, the strip-shaped flexible conductive wire 12 that supplies electric power to the heater portion 10 for securing the field of view can be guided radially outward along the tapered surface 35T of the lens barrel 30 and connected to the circuit board 40.

As described above, before the laser welding of the ring member 20 and the lens barrel 30, the four protruding portions 37 of the lens barrel 30 are fixed to the first surface 40a of the circuit board 40 via the adhesive. In this case, it is necessary to accurately align the lens barrel 30 and the circuit board 40. When the strip-shaped flexible conductive wire 12 is led out from any position, this alignment may be hindered. In the present embodiment, since the strip-shaped flexible conductive wire 12 is led out from the lens barrel 30 so as to be guided radially outward from the predetermined position P1 along the tapered surface 35T, the strip-shaped flexible conductive wire 12 can be prevented from becoming an obstacle when the lens barrel 30 and the circuit board 40 are aligned, and the vehicular camera 100 can be smoothly assembled.

The lens barrel 30 includes a groove portion 36 facing the optical axis L, extending from the predetermined position P1 between the first end portion 30a and the second end portion 30b to the second end portion 30b, and the tapered surface 35T is implemented by a bottom surface of the groove portion 36. Accordingly, the tapered surface 35T can be easily formed by the bottom surface of the groove portion 36.

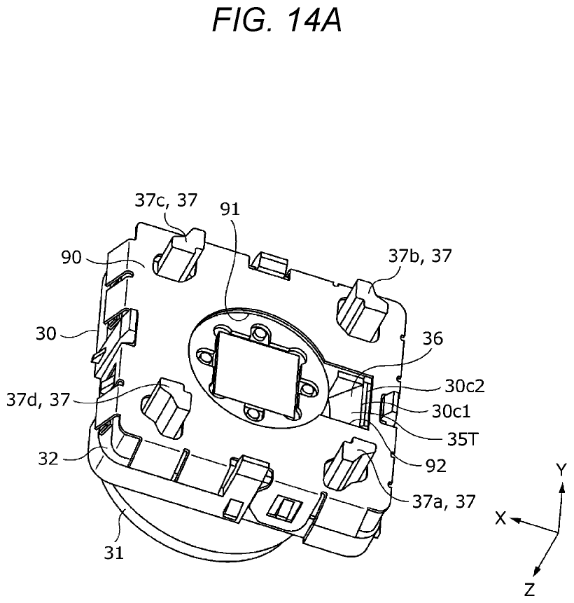

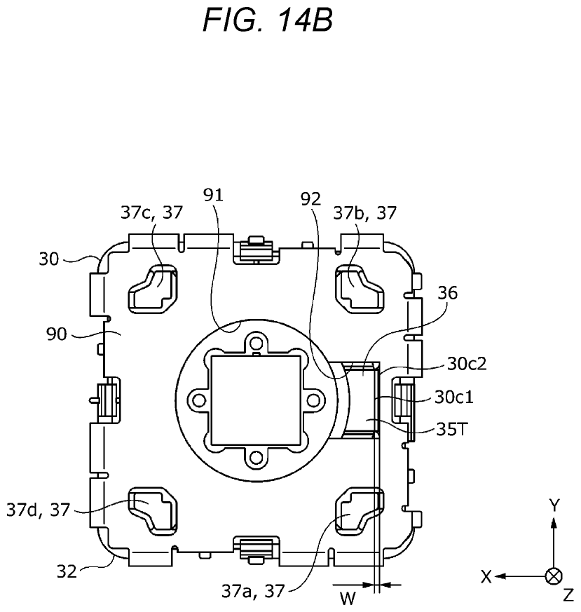

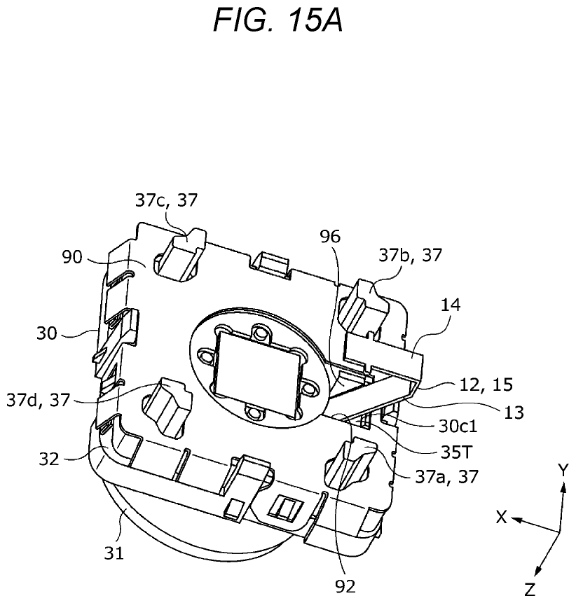

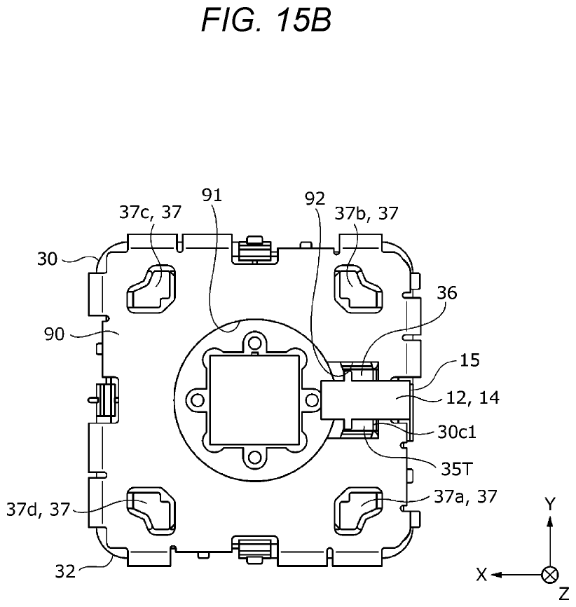

FIG. 14A is a perspective view of a state in which the front shield 90 is added to FIG. 12A, and FIG. 14B is a perspective view of a state in which the front shield 90 is added to FIG. 12B. FIG. 15A is a perspective view of a state in which the strip-shaped flexible conductive wire 12 and the front shield 90 are added to FIG. 12A, and FIG. 15B is a perspective view of a state in which the strip-shaped flexible conductive wire 12 and the front shield 90 are added to FIG. 12B.

At least a part of the front shield 90 is disposed between the lens barrel end surface 30c of the second end portion 30b of the lens barrel 30 and the first surface 40a of the circuit board 40 along the lens barrel end surface 30c over the entire circumference around the optical axis L. The front shield 90 includes a first hole 91 corresponding to the optical axis L, and the strip-shaped flexible conductive wire 12 is disposed across the front shield 90. Accordingly, the front shield 90 that shields noise can be disposed without being hindered by the strip-shaped flexible conductive wire 12.

The front shield 90 includes a second hole 92 through which the strip-shaped flexible conductive wire 12 passes. Accordingly, the strip-shaped flexible conductive wire 12 can pass through the front shield 90.

The first hole 91 and the second hole 92 of the front shield 90 are integrally formed. Accordingly, the first hole 91 and the second hole 92 can be easily formed.

Further, as illustrated in FIGS. 14A and 14B, in an intersection region 30c2 of the lens barrel end surface 30c, which is in contact with an intersection line 30c1 formed by the intersection of the tapered surface 35T of the lens barrel 30 with the lens barrel end surface 30c, at least a predetermined width W along the intersection line 30c1 is exposed in a direction from the front shield 90 toward the circuit board 40. Here, the predetermined width may not be constant. Accordingly, the strip-shaped flexible conductive wire 12 can be led out from the second hole 92 without being in contact with the front shield 90. At least the lens barrel end surface 30c is preferably made of a resin. Accordingly, wear of the strip-shaped flexible conductive wire 12 can be suppressed.

A first length of the strip-shaped flexible conductive wire 12 from a predetermined position P1 between the first end portion 30a and the second end portion 30b of the lens barrel 30 to the heater portion 10 is longer than a second length from the predetermined position P1 to the intersection line 30c1. Accordingly, the length of the tapered surface 35T can be shortened, and the lens barrel 30 can be easily molded.

As illustrated in FIG. 9, the other end portion 12b of the strip-shaped flexible conductive wire 12 is connected to the second surface 40b of the circuit board 40. In particular, the second surface 40b of the circuit board 40 includes a connector connection portion 47, and the other end portion 12b of the strip-shaped flexible conductive wire 12 is connected to the connector connection portion 47. Accordingly, electric power can be supplied to the strip-shaped flexible conductive wire 12.

As illustrated in FIGS. 7 and 9, the circuit board 40 includes an end surface 40c connecting the first surface 40a to the second surface 40b. As will be described later, the intermediate portion 15 of the strip-shaped flexible conductive wire 12 is disposed between the end surface 40c of the circuit board 40 and the inner surface 66 of the housing 60. Accordingly, the strip-shaped flexible conductive wire 12 can be routed to the second surface 40b of the circuit board 40. The structure around the intermediate portion 15 will be described later again.

As described above, the lens barrel 30 includes the flange portion 32, and the third end portion 63 of the housing 60 is connected to the flange portion 32 of the lens barrel 30. Accordingly, the lens barrel 30 and the housing 60 can be easily connected.

The tapered surface 35T of the lens barrel 30 is disposed over at least a part of the flange portion 32. Accordingly, the tapered surface 35T can be easily disposed.

The third end portion 63 of the housing 60 is bonded to the flange portion 32 of the lens barrel 30. Specifically, the third end portion 63 is bonded to the flange portion 32 via the ring member 20. Accordingly, the lens barrel 30 and the housing 60 can be easily bonded.

Further, the vehicular camera 100 includes an external connector 80 disposed at the fourth end portion 64 of the housing 60 so as to extend from the outside to the inside of the housing 60. The external connector 80 is electrically connected to the heater portion 10 and the imaging element 50. Specifically, at least a part of the external connector 80 is disposed at the fourth end portion 64 of the large-diameter cylindrical portion 61 of the housing 60, and the external connector 80 includes the first connector end portion 81 and the second connector end portion 82 opposite to the first connector end portion 81. The first connector end portion 81 is electrically connected to the circuit board 40, and is set to output an image signal from the imaging element 50 to the outside.

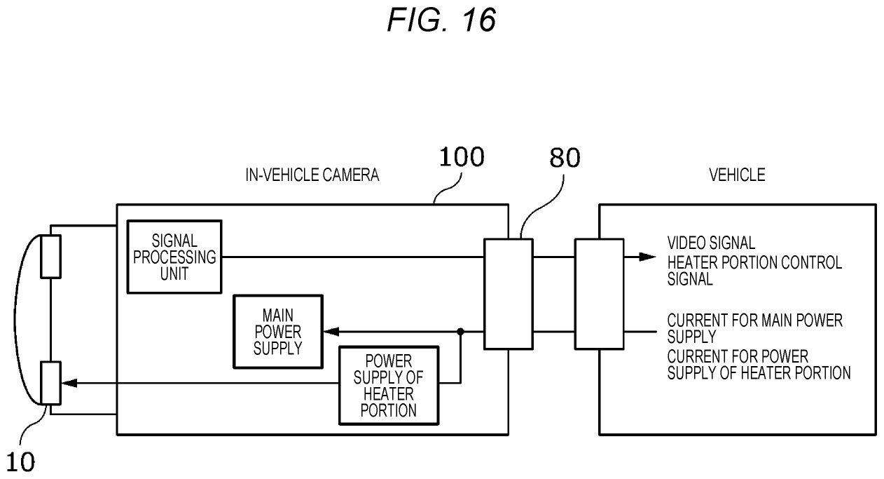

FIG. 16 is a circuit diagram of the vehicular camera 100 and the vehicle V. The vehicular camera 100 is connected to the vehicle V via the external connector 80. The vehicle V supplies a current for a main power supply of the vehicular camera 100 itself and a current for a power supply of the heater portion 10 via the external connector 80. A signal processing unit of the vehicular camera 100 supplies a signal of a video captured by the imaging element 50 and a control signal of the heater portion 10 to the vehicle V via the external connector 80. This makes it possible to supply electric power to the heater portion 10 and an electrical signal to the imaging element 50.

A connector bonding portion 48 to be bonded to the external connector 80 is disposed on the second surface 40b of the circuit board 40. Accordingly, the circuit board 40 and the external connector 80 can be easily connected. Specifically, the first connector end portion 81 of the external connector 80 is connected to the connector connection portion 47 via the connector bonding portion 48.

The housing 60 includes a housing end surface 64a that faces the circuit board 40 at the fourth end portion 64 and closes the large-diameter cylindrical portion 61, and the external connector 80 is disposed on the housing end surface 64a. Accordingly, the external connector 80 can be stably disposed.

As illustrated in FIG. 9, at least one lens 35 of the lens barrel 30 includes a plurality of lenses (first lens 35a to sixth lens 35f), and the heater portion 10 can heat a lens farthest from the imaging element 50 among the plurality of lenses (first lens 35a to sixth lens 35f), specifically, the first lens 35a. By heating the first lens 35a in which the field of view is most likely to be obstructed, it is possible to efficiently secure the field of view.

As described above, in the embodiment, the first width passing through the first center of the first shape of the circuit board 40 is larger than the second width passing through the second center of the second shape of the cross section of the inner surface 33 of the lens barrel 30. Further, the first width passing through the first center of the first shape of the circuit board 40 is the smallest among widths passing through the first center of the first shape of the circuit board 40, and the second width passing through the second center of the second shape of the inner surface cross section of the lens barrel 30 is the largest among widths passing through the second center of the second shape of the lens barrel 30.

Accordingly, the strip-shaped flexible conductive wire 12 can be reliably guided radially outward and connected to the circuit board 40. Therefore, when the lens barrel 30 and the circuit board 40 are aligned, the strip-shaped flexible conductive wire 12 can be prevented from becoming an obstacle, and the vehicular camera 100 can be smoothly assembled.

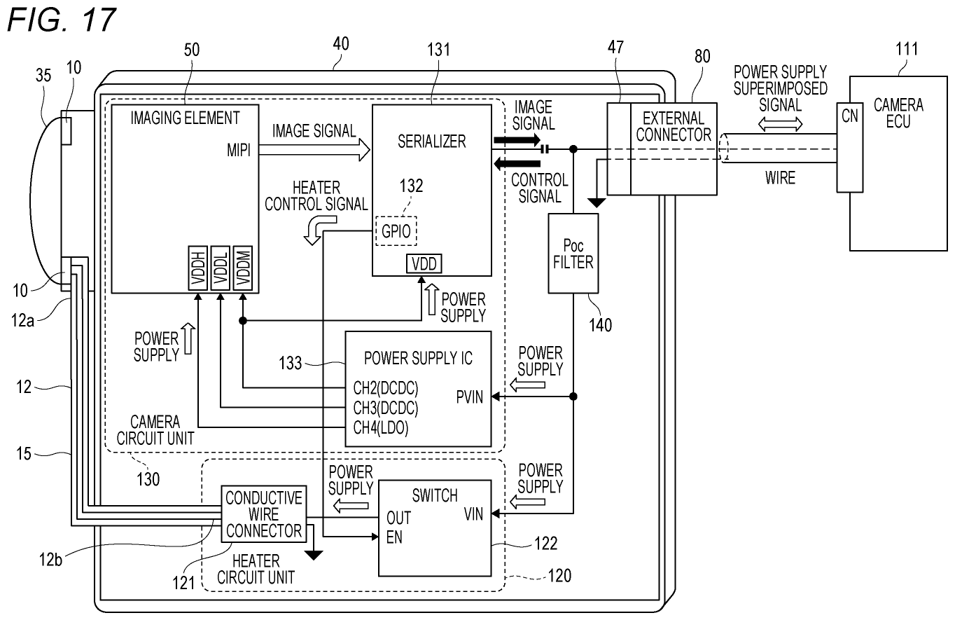

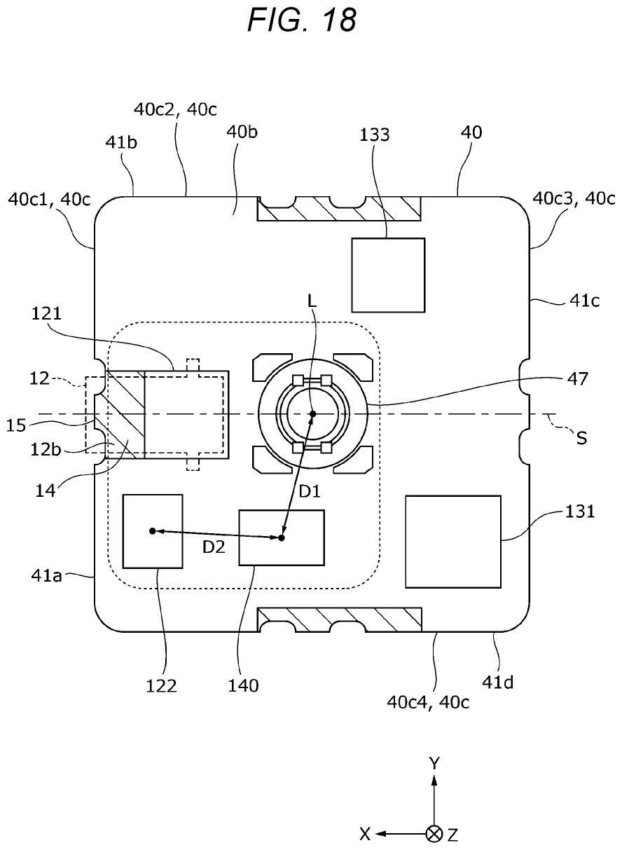

FIG. 17 is a detailed circuit diagram of the circuit board 40. FIG. 17 schematically illustrates electrical connection of each portion, and does not illustrate an arrangement structure of either the first surface 40a or the second surface 40b of the circuit board 40. FIG. 18 is a plan view of the second surface 40b of the circuit board 40, and illustrates an example of an arrangement structure of the second surface 40b.

FIG. 9 illustrates the connection between the other end portion 12b of the strip-shaped flexible conductive wire 12, which is the conductive wire portion, and the connector connection portion 47. More specifically, various circuits and the like are electrically connected between the other end portion 12b of the strip-shaped flexible conductive wire 12 and the connector connection portion 47.

The circuit board 40 includes a heater circuit unit 120 having a function of supplying electric power to the heater portion 10, and a camera circuit unit 130 having a function of supplying electric power mainly to a portion other than the heater portion 10 of the vehicular camera 100.

The heater circuit unit 120 includes a conductive wire connector 121 and a switch 122. The conductive wire connector 121 is disposed on the circuit board 40, the other end portion 12b of the strip-shaped flexible conductive wire 12 is connected thereto, and is electrically connected to the connector connection portion 47 and the strip-shaped flexible conductive wire 12. The conductive wire connector 121 functions as a conductive wire connection portion that connects the strip-shaped flexible conductive wire 12 to the circuit board 40.

The switch 122 is disposed on the circuit board 40, is electrically connected to the connector connection portion 47 and the conductive wire connector 121, and has a function of increasing or decreasing a voltage and/or current to be supplied to the heater portion 10.

As illustrated in FIG. 18, the connector connection portion 47, the switch 122, and the conductive wire connector 121 are disposed on the second surface 40b opposite to the first surface 40a on which the imaging element 50 of the circuit board 40 is disposed. The electric power for driving the vehicular camera 100 is supplied from the vehicle V to the heater portion 10 with a predetermined electric power via the external connector 80 as a connector, the connector connection portion 47, the switch 122, the conductive wire connector 121, and the strip-shaped flexible conductive wire 12.

According to the above configuration, the members for supplying electric power to the heater portion 10 for securing the field of view are collectively disposed on the second surface 40b of the circuit board 40. That is, at least the connector connection portion 47 connected to the external connector 80, and the conductive wire connector 121 and the switch 122 of the heater circuit unit 120 are disposed on the second surface 40b. Although the electric power supplied to the heater portion 10 is large and tends to lead to an increase in power consumption, electric power loss due to wiring resistance can be reduced and power consumption can be suppressed by collectively arranging the connector connection portion 47, the conductive wire connector 121, and the switch 122 on the second surface 40b and electrically connecting them.

The switch 122 can be switched between at least a first state and a second state by a control signal output from a switch control circuit 132 of the camera circuit unit 130 to be described later. When the switch 122 is in the first state, the first electric power is supplied from the switch 122 to the heater portion 10, and when the switch 122 is in the second state, the second electric power smaller than the first electric power is supplied from the switch 122 to the heater portion 10. The first state is, for example, a state in which the switch 122 is on, and the second state is, for example, a state in which the switch 122 is off. The second electric power includes zero electric power.

Accordingly, depending on the use situation of the vehicular camera 100, the state of the switch 122 can be switched to supply different power to the heater portion 10, thereby changing the output of the heater portion 10.

The external connector 80 may be, for example, a coaxial connector capable of supplying both the electric power and the signals. In this case, the external connector 80 can receive third electric power (third electric power>first electric power>second electric power), which is original electric power of the first electric power or the second electric power described above, from the vehicle V, supply the third electric power to the circuit board 40, and output electric power of the image signal output from the imaging element 50 to the vehicle V.

Corresponding to the function of the external connector 80 described above, a PoC filter 140, which is a filter circuit, is provided on the circuit board 40. The PoC filter 140 is electrically connected to the connector connection portion 47 and the switch 122, and can separate a part of the third electric power supplied from the external connector 80 and the electric power of the image signal output from the imaging element 50. As indicated by broken lines in FIG. 18, the PoC filter 140 may also be disposed on the second surface 40b of the circuit board 40.

Accordingly, by using the PoC filter 140 to separate the third electric power supplied from a power supply of the vehicle V via the external connector 80 and the image signal from the imaging element 50, it is possible to transmit the image signal and the third electric power in a superimposed manner through the external connector 80, which is a single coaxial cable, without adversely affecting signal quality. Further, the PoC filter 140 is also disposed on the second surface 40b and electrically connected to the connector connection portion 47 and the switch 122, so that the electric power loss due to the wiring resistance can be reduced, and the power consumption can be suppressed.

A part of the third electric power supplied from the external connector is supplied to the switch 122 via the PoC filter 140. Accordingly, a part of the third electric power is supplied to the switch 122, and the switch 122 can increase or decrease the voltage and/or current to be supplied to the heater portion 10. Instead of the PoC filter 140, another filter circuit may be used.

As illustrated in FIG. 18, in the second surface 40b of the circuit board 40, a first distance D1 between the center of the PoC filter 140 and the center of the connector connection portion 47 is set to be shorter than a second distance D2 between the center of the PoC filter 140 and the center of the switch 122 (D1<D2). The first distance D1 and the second distance D2 are distances in the plan view of the circuit board 40, that is, when viewed in the direction from the first surface 40a toward the second surface 40b of the circuit board 40 or the direction along the optical axis L.

Accordingly, since the PoC filter 140 is disposed closer to the connector connection portion 47 than to the switch 122, the distance (first distance D1) between the PoC filter 140 and the connector connection portion 47 can be shortened, and signal characteristics can be improved.

A serializer 131 of the camera circuit unit 130 is provided on the circuit board 40. The serializer 131 can be disposed on the first surface 40a or the second surface 40b of the circuit board 40, and is electrically connected to the connector connection portion 47 and the imaging element 50.

The image signal output from the imaging element 50 is a parallel signal. On the other hand, a signal suitable for being handled by the external connector 80, which is a coaxial connector, is a serial signal. The serializer 131 serves to convert the parallel signal (image signal) output from the imaging element 50 into a serial signal (parallel-to-serial conversion) and output the serial signal to the external connector 80. The image signal output from the imaging element 50 is not limited to the parallel signal, and may be the serial signal.

Accordingly, the serializer 131 can convert the parallel signal output from the imaging element 50 into the serial signal suitable for the external connector 80 without requiring synchronization signals and output the serial signal to the external connector 80.

As illustrated in FIG. 18, the serializer 131 may also be disposed on the second surface 40b of the circuit board 40. Accordingly, since the serializer 131 is also collectively disposed on the second surface 40b of the circuit board 40, the electric power loss due to the wiring resistance on the circuit board 40 can be reduced, and the power consumption can be suppressed.

Further, the switch control circuit 132 is provided on the circuit board 40. The switch control circuit 132 can be disposed on the first surface 40a or the second surface 40b of the circuit board 40, and outputs a control signal for switching between the first state and the second state to the switch 122. Accordingly, the switch 122 can switch between the first state and the second state based on the control signal from the switch control circuit 132. As illustrated in FIG. 17, the serializer 131 may function as the switch control circuit 132.

The control signal output by the switch control circuit 132 is output from the camera ECU (Electronic Control Unit) 111 mounted on the vehicle V, and is input to the switch control circuit 132 via the external connector 80.

Accordingly, the switch control circuit 132 can control the switch using the control signal output from a general ECU.

The ratio of the predetermined electric power supplied to the heater portion 10 to fourth electric power obtained by subtracting the predetermined electric power from the third electric power of the external connector 80 can be set to fall within a range of 1:2 to 2:1. Accordingly, even when the electric power supplied to the heater portion 10 is large in total power consumption of the vehicular camera 100, the vehicular camera 100 can be smoothly driven while maintaining the function of the heater portion 10. The fourth electric power is electric power consumed by the imaging element 50 and the like.

Further, a power supply integrated circuit (IC) 133 is provided on the circuit board 40. The power supply IC 133 can be disposed on the first surface 40a or the second surface 40b of the circuit board 40, and is electrically connected to the PoC filter 140, the imaging element 50, and the serializer 131. The power supply IC 133, for a specific application, not only combines a plurality of power supplies necessary for the system, but also performs power supply control such as control of a power supply activation sequence according to the system and on/off control of each power supply for reducing power consumption, and is also called a power supply management IC. The power supply IC 133 is, for example, a power management IC (PMIC).

A part of the third electric power supplied from the external connector 80 is supplied to the power supply IC 133 via the PoC filter 140, and then supplied from the power supply IC 133 to the imaging element 50 and the serializer 131. Accordingly, the power supply IC 133 can secure the electric power for driving the imaging element 50 and the serializer 131 from the third electric power.

As illustrated in FIG. 18, the power supply IC 133 may also be disposed on the second surface 40b of the circuit board 40. Accordingly, since the power supply IC 133 is also collectively disposed on the second surface 40b of the circuit board 40, the electric power loss due to the wiring resistance can be reduced, and the power consumption can be suppressed.

Next, the relationship between the strip-shaped flexible conductive wire 12 and the circuit board 40 will be described again. As illustrated in FIG. 9, the circuit board 40 has the end surface 40c between the first surface 40a and the second surface 40b. As described above, in the embodiment, the first shape of the circuit board 40 is the first quadrangular shape, and includes a first edge 41a, a second edge 41b, a third edge 41c, and a fourth edge 41d. Corresponding to the four sides, the end surface 40c includes a first end surface 40c1 corresponding to the first edge 41a, a second end surface 40c2 corresponding to the second edge 41b, a third end surface 40c3 corresponding to the third edge 41c, and a fourth end surface 40c4 corresponding to the fourth edge 41d. As described above, the strip-shaped flexible conductive wire 12 includes the intermediate portion 15 between the one end portion 12a and the other end portion 12b, the first connection portion 13, and the second connection portion 14. The intermediate portion 15 of the strip-shaped flexible conductive wire 12 is disposed between the inner surface 66 of the second cylindrical shape of the housing 60 and the first end surface 40c1 of the circuit board 40.

In the present embodiment, since the conductive wire portion connecting the heater portion 10 to the circuit board 40 is the strip-shaped flexible conductive wire 12, the strip-shaped flexible conductive wire 12 can be routed so as to pass through the inside of the lens barrel 30 and pass between the first end surface 40c1 of the end surface 40c of the circuit board 40 and the inner surface 66 of the large-diameter cylindrical portion 61 of the housing 60.

As illustrated in FIG. 7, the large-diameter cylindrical portion 61 of the housing 60 has a first side wall portion 65a, a second side wall portion 65b, a third side wall portion 65c, and a fourth side wall portion 65d. As illustrated in FIG. 18, the circuit board 40 has a first edge 41a corresponding to the first side wall portion 65a, a second edge 41b corresponding to the second side wall portion 65b, a third edge 41c corresponding to the third side wall portion 65c, and a fourth edge 41d corresponding to the fourth side wall portion 65d inside the housing 60 in the plan view of the second surface 40b of the circuit board 40.

As illustrated in FIGS. 9 and 18, at least a part of the intermediate portion 15 of the strip-shaped flexible conductive wire 12 is located between the first side wall portion 65a of the large-diameter cylindrical portion 61 of the housing 60 and the first edge 41a of the circuit board 40. Further, the connector connection portion 47 is disposed at a center portion of the second surface 40b of the circuit board 40 in the plan view of the second surface 40b of the circuit board 40, and the conductive wire connector 121 is disposed between the connector connection portion 47 and the first edge 41a of the circuit board 40 on the second surface 40b of the circuit board 40.

Accordingly, the strip-shaped flexible conductive wire 12 can be routed from between the first side wall portion 65a of the large-diameter cylindrical portion 61 of the housing 60 and the first edge 41a of the circuit board 40 to the second surface 40b of the circuit board 40 and connected to the conductive wire connector 121.

As illustrated in FIG. 9, at least one lens 35 of the lens barrel 30 includes a plurality of lenses, and the heater portion 10 can heat the first lens 35a farthest from the imaging element among the plurality of lenses 35. Accordingly, the field of view can be efficiently secured.

The lens barrel 30 includes the flange portion 32 extending in a direction away from the optical axis L over the entire circumference around the optical axis L at the second end portion 30b of the first cylindrical portion 31, and the third end portion 63 of the large-diameter cylindrical portion 61 of the housing 60 is connected to the flange portion 32 of the lens barrel 30. Accordingly, the lens barrel 30 and the housing 60 can be easily connected.

When the vehicular camera 100 is disposed in the vehicle V, the second connector end portion 82 of the external connector 80 is electrically connected to a wire of the vehicle V. Accordingly, the electric power from the vehicle V can be secured.

As described above, the heater portion 10 may be, for example, a PTC heater. Accordingly, power consumption can be reduced.

As described above, the filter circuit may be a power over coaxial cable (PoC) filter 140. By using the PoC filter 140 to separate the third electric power supplied from the power supply via the external connector 80 and the image signal from the imaging element 50, it is possible to transmit the image signal and the third electric power in a superimposed manner to one coaxial cable, without adversely affecting signal quality.

The strip-shaped flexible conductive wire 12 may be a flexible printed circuit board. Accordingly, the strip-shaped flexible conductive wire 12 can be easily formed.

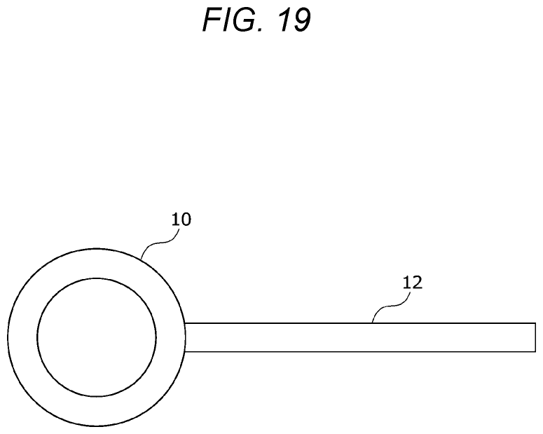

FIG. 19 illustrates a plan view of the heater portion 10 and the strip-shaped flexible conductive wire 12 in an unfolded state, and illustrates a state before being incorporated into the vehicular camera 100. In the present embodiment, the heater portion 10 has an annular shape and is disposed around the lens 35. The strip-shaped flexible conductive wire 12 has a linear and elongated shape extending from an outer edge of the heater portion 10. Since the conductive wire portion is linear and is the strip-shaped flexible conductive wire 12, when the strip-shaped flexible conductive wire 12 is bent and connected to the conductive wire connector 121, which is the conductive wire connection portion, the strip-shaped flexible conductive wire 12 is less likely to be twisted, and assemblability can be improved.

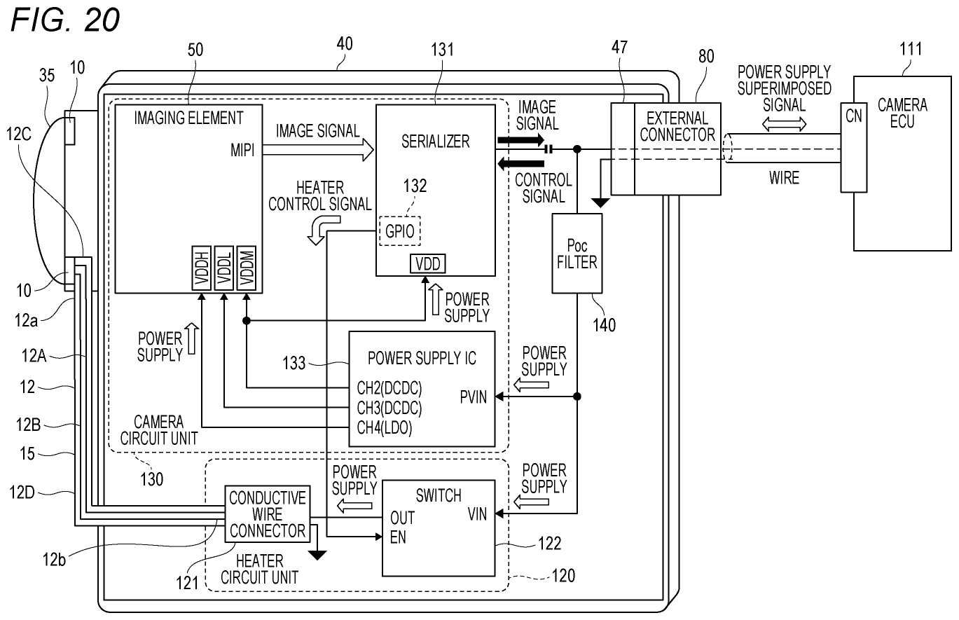

FIG. 20 is a plan view of the second surface 40b of the circuit board 40, which is different from the embodiment of FIG. 19. In the present embodiment, the strip-shaped flexible conductive wire 12 includes at least a first conductive wire 12A and a second conductive wire 12B. The first conductive wire 12A and the second conductive wire 12B serve as electric power supply lines for supplying electric power to the heater portion 10.

The strip-shaped flexible conductive wire 12 may also include a third conductive wire 12C and a fourth conductive wire 12D as illustrated. The third conductive wire 12C and the fourth conductive wire 12D are conductive wires electrically connected to a temperature sensor (a thermistor) (not illustrated) disposed in the vicinity of the lens 35.

As described above, the end surface 40c of the circuit board 40 has the first end surface 40c1 on the first edge 41a. Further, as illustrated in FIG. 18, the connector connection portion 47 is disposed on the optical axis L on the second surface 40b of the circuit board 40. Further, the conductive wire connector 121 is disposed between the first edge 41a of the first shape of the circuit board 40 and the connector connection portion 47 on the second surface 40b of the circuit board 40.

As described above, the strip-shaped flexible conductive wire 12 includes the intermediate portion 15, the first connection portion 13, and the second connection portion 14. The intermediate portion 15 is disposed between the inner surface 66 of the second cylindrical shape of the housing 60 and the first end surface 40c1 of the circuit board 40. The intermediate portion 15 is disposed at a position where a straight line S that is orthogonal to the first end surface 40c1 of the circuit board 40 and intersects the optical axis L penetrates. The straight line S is a theoretical auxiliary line and is not actually illustrated on the circuit board 40.

Electric power is required to drive the heater portion 10, and this electric power is supplied to the heater portion 10, for example, from the wire of the vehicle V via the external connector 80, the connector bonding portion 48, and the connector connection portion 47, and from the conductive wire connector 121 via the first conductive wire 12A and the second conductive wire 12B provided across the second connection portion 14, the intermediate portion 15, and the first connection portion 13 of the strip-shaped flexible conductive wire 12.

According to the present embodiment, the strip-shaped flexible conductive wire 12 that supplies the electric power to the heater portion 10 for securing the field of view is formed by bending a linear and elongated form as illustrated in FIG. 19. That is, as illustrated in FIG. 9, the strip-shaped flexible conductive wire 12 is formed by being bent only in the X direction to bypass other members, but is not bent in the Y direction to bypass other members. Therefore, in order to suppress an increase in the length of the strip-shaped flexible conductive wire 12, the amount of material required for the strip-shaped flexible conductive wire 12 can be reduced, the electric power loss can be reduced, and the power consumption can be suppressed.

As described above, the lens barrel 30 has four protruding portions 37 at the second end portion 30b, and the four protruding portions 37 are a first protruding portion 37a, a second protruding portion 37b, a third protruding portion 37c, and a fourth protruding portion 37d, respectively. The first protruding portion 37a protrudes from a first portion 30b1 of the second end portion 30b toward the first surface 40a of the circuit board 40. The second protruding portion 37b protrudes from a second portion 30b2 of the second end portion 30b toward the first surface 40a of the circuit board 40. The third protruding portion 37c protrudes from a third portion 30b3 of the second end portion 30b toward the first surface 40a of the circuit board 40. The fourth protruding portion 37d protrudes from a fourth portion 30b4 of the second end portion 30b toward the first surface 40a of the circuit board 40.

A first distance between the first protruding portion 37a and the second protruding portion 37b is shorter than a second distance between the first protruding portion 37a and the third protruding portion 37c, a third distance between the second protruding portion 37b and the third protruding portion 37c is shorter than the second distance, and a fourth distance between the third protruding portion 37c and the fourth protruding portion 37d is shorter than the second distance.

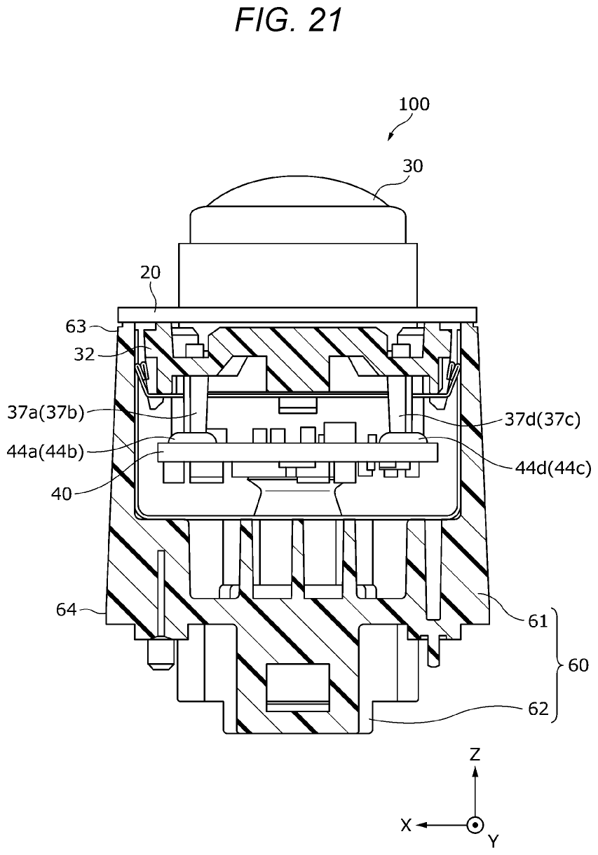

FIG. 21 is a cross-sectional view taken along a line III-III of FIG. 8, and illustrates that, unlike the cross section of FIG. 9, each of the first protruding portion 37a, the second protruding portion 37b, the third protruding portion 37c, and the fourth protruding portion 37d is connected to the first surface 40a of the circuit board 40 via the adhesive. That is, the first protruding portion 37a of the lens barrel 30 is connected to the first surface 40a via a first adhesive 44a, the second protruding portion 37b is connected to the first surface 40a via a second adhesive 44b, the third protruding portion 37c is connected to the first surface 40a via a third adhesive 44c, and the fourth protruding portion 37d is connected to the first surface 40a via a fourth adhesive 44d.

With such a configuration, the circuit board 40 can support the lens barrel 30 via the protruding portion, and the lens barrel 30 can be more stably supported using not only the housing 60 but also the internal circuit board 40. In order to stably support the lens barrel 30 by the circuit board 40, there may be three protruding portions, and for example, the fourth protruding portion 37d may be omitted.

As illustrated in FIGS. 13A, 13B, 15A, and 15B, at least a part of the first connection portion 13 of the strip-shaped flexible conductive wire 12 is disposed between the first protruding portion 37a and the second protruding portion 37b. Accordingly, it is possible to prevent interference between the strip-shaped flexible conductive wire 12 and the first and second protruding portions 37a and 37b.

At least a part of the first connection portion 13 of the strip-shaped flexible conductive wire 12, specifically, a portion disposed along the inner surface 33 of the first connection portion 13 is disposed along the direction of the optical axis L in the lens barrel 30. Accordingly, it is possible to suppress an increase in the length of the first connection portion 13 of the strip-shaped flexible conductive wire 12.

As illustrated in FIG. 18, the intermediate portion 15 of the strip-shaped flexible conductive wire 12 faces the midpoint of the first edge 41a of the first end surface 40c1 of the circuit board 40 in a length direction. Accordingly, since the intermediate portion 15 is disposed to face the midpoint of the first edge 41a, it is possible to prevent the strip-shaped flexible conductive wire 12 from being deviated in a specific direction, specifically, the Y direction, and to suppress an increase in the length of the strip-shaped flexible conductive wire 12.

The second connection portion 14 of the strip-shaped flexible conductive wire 12 is disposed along the straight line S intersecting the optical axis L. Accordingly, it is possible to suppress an increase in the length of the second connection portion 14 of the strip-shaped flexible conductive wire 12.

Further, the connector connection portion 47 is disposed at the center of the second surface 40b of the circuit board 40. The center of the second surface 40b coincides with the optical axis L. Accordingly, the external connector 80 can be connected to the center of the circuit board 40, which can, for example, facilitate design.

As described above, the first shape of the circuit board 40 has the first edge 41a, the second edge 41b, the third edge 41c, and the fourth edge 41d, and the end surface 40c of the circuit board 40 includes the first end surface 40c1 on the first edge 41a, the second end surface 40c2 on the second edge 41b, the third end surface 40c3 on the third edge 41c, and the fourth end surface 40c4 on the fourth edge 41d. That is, in the embodiment, the first shape of the circuit board 40 is the first quadrangular shape. Accordingly, the circuit board 40 can be easily formed.

The second end portion 30b of the first cylindrical shape of the lens barrel 30 has the second shape in the plan view of the lens barrel 30, and the second shape is a quadrangular shape. That is, the flange portion 32 has the second shape and the quadrangular shape. Accordingly, the second end portion 30b of the lens barrel 30 can be easily formed, and can match the shape of the housing 60.

In order to remove foreign matter, an ultrasonic transducer that vibrates a lens may be disposed in a lens barrel. The strip-shaped flexible conductive wire 12 as a conductive wire portion can be applied not only to the heater portion that heats the lens, but also to a case where electric power is supplied to such an ultrasonic transducer.

As described above, at least the following matters are described in the present disclosure. Components corresponding to those in the embodiment are illustrated in parentheses, but the present disclosure is not limited thereto.

(A1) A vehicular camera (vehicular camera 100), including:
a lens barrel (lens barrel 30) including an inner surface (inner surface 33) and an outer surface (outer surface 34), having a first cylindrical shape along an optical axis (optical axis L), and including a first end portion (first end portion 30a), a second end portion (second end portion 30b) opposite to the first end portion, and at least one lens (lens 35) disposed along the optical axis;
an imaging element (imaging element 50) disposed on the optical axis closer to the second end portion than to the first end portion of the first cylindrical shape of the lens barrel;
a circuit board (circuit board 40) having a first shape in a plan view, and including a first surface (first surface 40a) and a second surface (second surface 40b) opposite to the first surface, the imaging element being disposed on the first surface; and
a housing (housing 60) accommodating at least the imaging element and the circuit board, having a second cylindrical shape along the optical axis, and including a third end portion (third end portion 63) connected to the lens barrel and a fourth end portion (fourth end portion 64) opposite to the third end portion;
a heater portion (heater portion 10) disposed on the first end portion of the lens barrel and configured to generate heat by electric power; and
a strip-shaped flexible conductive wire (strip-shaped flexible conductive wire 12) having one end portion (one end portion 12a) connected to the heater portion and another end portion (the other end portion 12b) connected to the circuit board, and configured to supply electric power to the heater portion, in which
in the inner surface of the lens barrel, an inner surface cross section orthogonal to the optical axis has a second shape,
a first width passing through a first center of the circuit board having the first shape is larger than a second width passing through a second center of the inner surface cross section of the lens barrel having the second shape,
a first portion (first portion 13) of the strip-shaped flexible conductive wire closer to the heater portion than to the circuit board is disposed between the inner surface and the outer surface of the lens barrel along a direction of the optical axis,
a second portion (second portion 14) of the strip-shaped flexible conductive wire closer to the circuit board than the first portion is disposed such that the second portion moves away from the optical axis as it goes from the first portion toward the circuit board, and
the lens barrel includes a tapered surface (tapered surface 35T) facing the optical axis and formed to move away from the optical axis as it goes from a predetermined position (predetermined position P1) between the first end portion and the second end portion toward the second end portion while being disposed along the second portion of the strip-shaped flexible conductive wire.

Accordingly, the strip-shaped flexible conductive wire that supplies electric power to the heater portion for securing the field of view can be guided radially outward along the tapered surface of the lens barrel and connected to the circuit board. Therefore, when the lens barrel and the circuit board are aligned, the strip-shaped flexible conductive wire can be prevented from becoming an obstacle, and the vehicular camera can be smoothly assembled.

(A2) The vehicular camera according to (A1), in which
the lens barrel includes a groove portion (groove portion 36) facing the optical axis, extending from the predetermined position between the first end portion and the second end portion to the second end portion, and
the tapered surface is a bottom surface of the groove portion.

Accordingly, the tapered surface can be easily formed by the bottom surface of the groove portion.

(A3) The vehicular camera according to (A1), in which
the second end portion of the lens barrel has a lens barrel end surface (lens barrel end surface 30c) at least partially facing the circuit board, and further includes a planar conductive member (front shield 90) including a first hole (first hole 91) corresponding to the optical axis, at least a part of the front shield being disposed between the lens barrel end surface and the first surface of the circuit board along the lens barrel end surface over an entire circumference around the optical axis, and
the strip-shaped flexible conductive wire is disposed across the planar conductive member.

Accordingly, the planar conductive member that shields noise can be disposed without being hindered by the strip-shaped flexible conductive wire.

(A4) The vehicular camera according to (A3), in which
the planar conductive member includes a second hole (second hole 92) through which the strip-shaped flexible conductive wire passes.

Accordingly, the strip-shaped flexible conductive wire can pass through the planar conductive member.

(A5) The vehicular camera according to (A4), in which
the first hole and the second hole of the planar conductive member are integrally formed.

Accordingly, the first hole and the second hole can be easily formed.

(A6) The vehicular camera according to (A3), in which
in an intersection region (intersection region 30c2) of the lens barrel end surface, which is in contact with an intersection line (intersection line 30c1) formed by intersection of the tapered surface of the lens barrel with the lens barrel end surface, at least a predetermined width along the intersection line is exposed in a direction from the planar conductive member toward the circuit board.

Accordingly, the strip-shaped flexible conductive wire can be led out from the second hole of the planar conductive member without being brought into contact with the planar conductive member.

(A7) The vehicular camera according to (A6), in which
a first length of the strip-shaped flexible conductive wire from the predetermined position between the first end portion of the lens barrel and the second end portion of the lens barrel to the heater portion is longer than a second length thereof from the predetermined position between the first end portion of the lens barrel and the second end portion of the lens barrel to the intersection line.

Accordingly, the length of the tapered surface can be shortened, and the lens barrel can be easily molded.

(A8) The vehicular camera according to (A1), in which
the other end portion of the strip-shaped flexible conductive wire is connected to the second surface of the circuit board.

Accordingly, electric power can be supplied to the strip-shaped flexible conductive wire.

(A9) The vehicular camera according to (A8), in which
the second surface of the circuit board includes a connector connection portion (connector connection portion 47), and
the other end portion of the strip-shaped flexible conductive wire is connected to the connector connection portion.

Accordingly, electric power can be supplied to the strip-shaped flexible conductive wire.

(A10) The vehicular camera according to (A8), in which
the circuit board has an end surface (end surface 40c) connecting the first surface to the second surface, and
a part of the strip-shaped flexible conductive wire between the second portion and the other end portion is disposed between the end surface of the circuit board and the inner surface of the housing.

Accordingly, the strip-shaped flexible conductive wire can be routed on the second surface of the circuit board.

(A11) The vehicular camera according to (A1), in which
the lens barrel includes, at the second end portion, a flange portion (flange portion 32) extending in a direction away from the optical axis over an entire circumference around the optical axis, and
the third end portion of the housing is connected to the flange portion of the lens barrel.

Accordingly, the lens barrel and the housing can be easily connected.

(A12) The vehicular camera according to (A11), in which
the tapered surface of the lens barrel is disposed over at least a part of the flange portion.

Accordingly, the tapered surface can be easily disposed.

(A13) The vehicular camera according to (A11), in which
the third end portion of the housing is bonded to the flange portion of the lens barrel.

Accordingly, the lens barrel and the housing can be easily bonded.

(A14) The vehicular camera according to (A1), further including:
an external connector (external connector 80) disposed on the fourth end portion of the second cylindrical shape of the housing and extending from outside to inside of the housing, in which
the external connector is electrically connected to the heater portion and the imaging element.

This makes it possible to supply electric power to the heater portion and an electrical signal to the imaging element.

(A15) The vehicular camera according to (A14), in which
the second surface of the circuit board is provided with a connector bonding portion (connector bonding portion 48) configured to be joined to the external connector.

Accordingly, the circuit board and the external connector can be easily connected.

(A16) The vehicular camera according to (A14), in which
the housing includes, at the fourth end portion of the second cylindrical shape, a housing end surface (housing end surface 64a) that faces the circuit board and closes the second cylindrical shape, and
the external connector is disposed on the housing end surface.

Accordingly, the external connector can be stably disposed.

(A17) The vehicular camera according to (A1), in which
the at least one lens of the lens barrel includes a plurality of lenses, and
the heater portion is able to heat a lens farthest from the imaging element among the plurality of lenses.

Accordingly, the field of view can be efficiently secured.

(A18) The vehicular camera according to (A1), in which
the first width passing through the first center of the first shape of the circuit board is the smallest among widths passing through the first center of the first shape of the circuit board, and
the second width passing through the second center of the second shape of the inner surface section of the lens barrel is the largest among widths passing through the second center of the second shape of the lens barrel.

Accordingly, the strip-shaped flexible conductive wire can be reliably guided radially outward and connected to the circuit board. Therefore, when the lens barrel and the circuit board are aligned, the strip-shaped flexible conductive wire can be prevented from becoming an obstacle, and the vehicular camera can be smoothly assembled.

(A19) The vehicular camera according to (A1), in which
the heater portion is a PTC heater.

Accordingly, power consumption can be reduced.

(A20) The vehicular camera according to (A1), in which
the strip-shaped flexible conductive wire is a flexible substrate having polyimide as a base material.

Accordingly, the strip-shaped flexible conductive wire can be easily formed.

(B1) A vehicular camera (vehicular camera 100) including:
a lens barrel (lens barrel 30) having a first cylindrical shape along an optical axis (optical axis L), and including a first end portion of the first cylindrical shape (first end portion 30a), a second end portion of the first cylindrical shape (second end portion 30b) opposite to the first end portion, and at least one lens (lens 35) disposed along the optical axis;
an imaging element (imaging element 50) disposed on the optical axis and closer to the second end portion than to the first end portion of the first cylindrical shape of the lens barrel;
a circuit board (circuit board 40) including a first surface (first surface 40a), a second surface (second surface 40b) opposite to the first surface, and an end surface (40c) connecting the first surface to the second surface, the imaging element being disposed on the first surface;
a housing (housing 60) having a second cylindrical shape, including a third end portion of the second cylindrical shape (third end portion 63), a fourth end portion (fourth end portion 64) of the second cylindrical shape disposed farther away from the first end portion of the first cylindrical shape of the lens barrel than the third end portion, an inner surface of the second cylindrical shape, and an outer surface of the second cylindrical shape, and accommodating at least the imaging element and the circuit board;
a connector (external connector 80) configured to output an image signal from the imaging element to the outside, having at least a part disposed on the fourth end portion of the second cylindrical shape of the housing, and including a first connector end portion (first connector end portion 81) and a second connector end portion (second connector end portion 82) opposite to the first connector end portion, the first connector end portion being electrically connected to the circuit board;
a connector connection portion (connector connection portion 47) that is disposed on the circuit board and to which the first connector end portion of the connector is connected;
a heater portion (heater portion 10) disposed at the first end portion of the first cylindrical shape of the lens barrel and configured to heat the at least one lens;
a conductive wire portion (strip-shaped flexible conductive wire 12) having one end portion connected to the heater portion and another end portion opposite to the one end portion, and electrically connected to the heater portion;
a conductive wire connection portion (conductive wire connector 121) that is disposed on the circuit board, to which the other end portion of the conductive wire portion is connected, and that is electrically connected to the connector connection portion and the conductive wire portion; and
a switch (switch 122) disposed on the circuit board, electrically connected to the connector connection portion and the conductive wire connection portion, and configured to increase or decrease a voltage and/or current to be supplied to the heater portion, in which
the connector connection portion, the switch, and the conductive wire connection portion are disposed on the second surface of the circuit board opposite to the first surface on which the imaging element is disposed,
the conductive wire portion has an intermediate portion (15) between the one end portion and the other end portion,
the intermediate portion of the conductive wire portion extends from the one end portion connected to the heater portion toward the first surface of the circuit board, and passes between the end surface of the circuit board and the inner surface of the second cylindrical shape of the housing,
the conductive wire portion includes a first conductive wire (12A) and a second conductive wire (12B), and
the conductive wire portion supplies predetermined electric power to the heater portion via the connector, the connector connection portion, the switch, the conductive wire connection portion, and the first conductive wire and the second conductive wire of the conductive wire portion.

Accordingly, since the members for supplying electric power to the heater portion for securing the field of view are collectively disposed on the second surface of the circuit board, electric power loss due to wiring resistance can be reduced, and power consumption can be suppressed.

(B2) The vehicular camera according to (B1), in which
the first conductive wire of the conductive wire portion, the heater portion, and the second conductive wire of the conductive wire portion constitute a part of a closed circuit.

Accordingly, the electric power can be supplied to the heater portion.

(B3) The vehicular camera according to (B1), in which
the intermediate portion of the conductive wire portion extends from the one end portion connected to the heater portion through an inside of the lens barrel toward the first surface of the circuit board, and passes between the end surface of the circuit board and the inner surface of the second cylindrical shape of the housing.

Accordingly, the conductive wire portion can be routed such that the intermediate portion of the conductive wire portion passes through the inside of the lens barrel and passes between the end surface of the circuit board and the inner surface of the second cylindrical shape of the housing.

(B4) The vehicular camera according to (B3), further including:
a shield portion (70) surrounding the circuit board, in which
a part of the shield portion is disposed between the inner surface of the second cylindrical shape of the housing and the end surface of the circuit board, and
the part of the shield portion is disposed between the inner surface of the second cylindrical shape of the housing and the intermediate portion of the conductive wire portion.

Accordingly, the part of the shield portion can be disposed between the inner surface of the second cylindrical shape of the housing and the intermediate portion of the conductive wire portion.

(B5) The vehicular camera according to (B1), in which
when the switch is in a first state, a first electric power is supplied from the switch to the heater portion, and
when the switch is in a second state, a second electric power smaller than the first electric power is supplied from the switch to the heater portion.

Accordingly, depending on the use situation of the vehicular camera, the state of the switch can be switched to supply different power to the heater portion, thereby changing the output of the heater portion.

(B6) The vehicular camera according to (B1), in which
the connector is a coaxial connector,
the vehicular camera further includes a filter circuit (PoC filter 140) electrically connected to the connector connection portion and the switch and configured to separate a part of third electric power supplied from the connector and electric power of the image signal output from the imaging element, and
the filter circuit is disposed on the second surface of the circuit board opposite to the first surface where the imaging element is disposed.

Accordingly, by using the filter circuit to separate the third electric power supplied from the power supply via the connector and the image signal from the imaging element, it is possible to transmit the image signal and the third electric power in a superimposed manner to the coaxial cable, without adversely affecting signal quality. Further, by disposing the filter circuit on the second surface and electrically connecting it to the connector connection portion and the switch, the electric power loss due to the wiring resistance can be reduced, and the power consumption can be suppressed.

(B7) The vehicular camera according to (B6), in which
the part of the third electric power is supplied to the switch via the filter circuit.

Accordingly, a part of the third electric power is supplied to the switch, and the switch can increase or decrease the voltage and/or current to be supplied to the heater portion.

(B8) The vehicular camera according to (B7), in which
on the second surface of the circuit board opposite to the first surface on which the imaging element is disposed, a first distance between a center of the filter circuit and a center of the connector connection portion is shorter than a second distance between the center of the filter circuit and a center of the switch.

Accordingly, since the filter circuit is disposed closer to the connector connection portion than to the switch, signal characteristics can be improved.

(B9) The vehicular camera according to (B6), further including:
a serializer (serializer 131) disposed on the first surface or the second surface of the circuit board and electrically connected to the connector connection portion and the imaging element, in which
the image signal output from the imaging element is a parallel signal, and
the serializer converts the parallel signal into a serial signal and outputs the serial signal to the connector.

Accordingly, the serializer can convert the parallel signal output from the imaging element into the serial signal suitable for the connector without signal synchronization, and output the serial signal to the connector.

(B10) The vehicular camera according to (B9), in which
the serializer is disposed on the second surface of the circuit board.

Accordingly, since the serializer is also collectively disposed on the second surface of the circuit board, the electric power loss due to the wiring resistance can be reduced, and the power consumption can be suppressed.

(B11) The vehicular camera according to (B5), further including:
a switch control circuit (switch control circuit 132) on the first surface or the second surface of the circuit board, in which
the switch control circuit outputs a control signal for switching between the first state and the second state to the switch.

Accordingly, the switch can switch between the first state and the second state based on the control signal from the switch control circuit.

(B12) The vehicular camera according to (B11), in which
the control signal is output from an electronic control unit (ECU) mounted on a vehicle, and is input into the switch control circuit via the connector.

Accordingly, the switch control circuit can control the switch using the control signal output from a general ECU.

(B13) The vehicular camera according to (B1), in which
a ratio of the predetermined electric power supplied to the heater portion to fourth electric power obtained by subtracting the predetermined electric power from the third electric power is in a range of 1:2 to 2:1.

Accordingly, even when the electric power supplied to the heater portion is large in total power consumption of the vehicular camera, the vehicular camera can be smoothly driven while maintaining the function of the heater portion.

(B14) The vehicular camera according to (B9), further including:
a power supply integrated circuit (IC) (power supply IC 133) disposed on the first surface or the second surface of the circuit board and electrically connected to the filter circuit, the imaging element, and the serializer, in which
a part of the third electric power supplied from the connector is supplied to the power supply IC via the filter circuit, and then is supplied from the power supply IC to the imaging element and the serializer.

Accordingly, the power supply IC can secure the electric power for driving the imaging element and the serializer from the third electric power.

(B15) The vehicular camera according to (B14), in which
the power supply IC is disposed on the second surface of the circuit board.

Accordingly, since the power supply IC is also collectively disposed on the second surface of the circuit board, the electric power loss due to the wiring resistance can be reduced, and the power consumption can be suppressed.

(B16) The vehicular camera according to (B1), in which
the second cylindrical shape of the housing has a first side wall portion (first side wall portion 65a), a second side wall portion (second side wall portion 65b), a third side wall portion (third side wall portion 65c), and a fourth side wall portion (fourth side wall portion 65d),
the circuit board has, in the plan view of the second surface of the circuit board, a first edge portion (first edge portion 41a) corresponding to the first side wall portion, a second edge portion (second edge portion 41b) corresponding to the second side wall portion, a third edge portion (third edge portion 41c) corresponding to the third side wall portion, and a fourth edge portion (fourth edge portion 41d) corresponding to the fourth side wall portion,
at least a part of the intermediate portion of the conductive wire portion is between the first side wall portion of the second cylindrical shape of the housing and the first edge portion of the circuit board,
the connector connection portion is disposed at a center portion of the second surface of the circuit board in the second surface of the circuit board, and
the conductive wire connection portion is disposed between the connector connection portion and the first edge portion of the circuit board in the second surface of the circuit board.

Accordingly, the strip-shaped flexible conductive wire can be routed from between the first side wall portion of the second cylindrical shape of the housing and the first edge portion of the circuit board to the second surface of the circuit board and connected to the conductive wire connection portion.

(B17) The vehicular camera according to (B1), in which
the at least one lens of the lens barrel includes a plurality of lenses, and
the heater portion is able to heat a lens farthest from the imaging element among the plurality of lenses.

Accordingly, the field of view can be efficiently secured.

(B18) The vehicular camera according to (B17), in which
the lens barrel further includes, at the second end portion of the first cylindrical shape, a flange portion (flange portion 32) extending in a direction away from the optical axis over an entire circumference around the optical axis, and
the third end portion of the second cylindrical shape of the housing is connected to the flange portion of the lens barrel.

Accordingly, the lens barrel and the housing can be easily connected.

(B19) The vehicular camera according to (B1), in which
when the vehicular camera is disposed in a vehicle, the second connector end portion of the connector is electrically connected to the wire of the vehicle.

Accordingly, the electric power from the vehicle can be secured.

(B20) The vehicular camera according to (B1), in which
the conductive wire portion is a flexible printed circuit board.

Accordingly, the strip-shaped flexible conductive wire can be easily formed.

(C1) A vehicular camera (vehicular camera 100) including:
a lens barrel (lens barrel 30) having a first cylindrical shape along the optical axis (optical axis L), including a first end portion of the first cylindrical shape (first end portion 30a), a second end portion of the first cylindrical shape (second end portion 30b) opposite to the first end portion, and at least one lens (lens 35) disposed along the optical axis;
an imaging element (imaging element 50) disposed on the optical axis and closer to the second end portion than to the first end portion of the first cylindrical shape of the lens barrel;
a circuit board (circuit board 40) having a first shape in a plan view, and including a first surface (first surface 40a), a second surface (second surface 40b) opposite to the first surface, and an end surface (end surface 40c) connecting the first surface to the second surface, the imaging element being disposed on the first surface;
a housing (housing 60) having a second cylindrical shape along the optical axis, including an inner surface (inner surface 66) of the second cylindrical shape, an outer surface (outer surface 67) of the second cylindrical shape, a third end portion (third end portion 63) of the second cylindrical shape, and a fourth end portion (fourth end portion 64) of the second cylindrical shape disposed farther away from the first end portion of the first cylindrical shape of the lens barrel than the third end portion, and accommodating at least the imaging element and the circuit board;
a connector (external connector 80) configured to output an image signal from the imaging element to the outside, having at least a part disposed on the fourth end portion of the second cylindrical shape of the housing, and including a first connector end portion (first connector end portion 81) and a second connector end portion (second connector end portion 82) opposite to the first connector end portion, the first connector end portion being electrically connected to the circuit board;
a connector connection portion (connector connection portion 47) that is disposed on the second surface of the circuit board and to which the first connector end portion of the connector is connected;
a heater portion (heater portion 10) disposed at the first end portion of the first cylindrical shape of the lens barrel and configured to heat the at least one lens;
a conductive wire portion (strip-shaped flexible conductive wire 12) including at least a first conductive wire (first conductive wire 12A) and a second conductive wire (second conductive wire 12B), one end portion (one end portion 12a) connected to the heater portion, and another end portion (the other end portion 12b) opposite to the one end portion; and
a conductive wire connection portion (conductive wire connector 121) that is disposed on the second surface of the circuit board, to which the other end portion of the conductive wire portion is connected, and that is electrically connected to the connector connection portion and the conductive wire portion, in which
the first shape of the circuit board has a first edge (first edge 41a),
the end surface of the circuit board has a first end surface (first end surface 40c1) on the first edge,
the connector connection portion is disposed on the optical axis on the second surface of the circuit board,
the conductive wire connection portion is disposed between the first edge of the first shape and the connector connection portion on the second surface of the circuit board,
the conductive wire portion includes
   an intermediate portion (intermediate portion 15) located between the one end portion and the other end portion,
   a first connection portion (first connection portion 13) connecting the one end portion to the intermediate portion, and
   a second connection portion (second connection portion 14) connecting the intermediate portion to the other end portion,
the intermediate portion of the conductive wire portion is disposed between the inner surface of the second cylindrical shape of the housing and the first end surface of the circuit board,
the intermediate portion of the conductive wire portion is disposed at a position through which a straight line orthogonal to the first end surface of the circuit board and intersecting the optical axis passes, and
electric power is supplied from the conductive wire connection portion to the heater portion via the first conductive wire and the second conductive wire provided across the second connection portion, the intermediate portion, and the first connection portion of the conductive wire portion.

Accordingly, in order to suppress an increase in the length of the conductive wire portion that supplies electric power to the heater portion for securing the field of view, the amount of material required for the conductive wire portion can be reduced, the loss of electric power can be reduced, and power consumption can be suppressed.

(C2) The vehicular camera according to (C1), in which
the lens barrel includes
   a first protruding portion (first protruding portion 37a) protruding from a first portion (first portion 30b1) of the second end portion toward the first surface of the circuit board,
   a second protruding portion (second protruding portion 37b) protruding from a second portion (second portion 30b2) of the second end portion toward the first surface of the circuit board, and
   a third protruding portion (third protruding portion 37c) protruding from a third portion (third portion 30b3) of the second end portion toward the first surface of the circuit board,
a first distance between the first protruding portion and the second protruding portion is shorter than a second distance between the first protruding portion and the third protruding portion,
a third distance between the second protruding portion and the third protruding portion is shorter than the second distance,
the first protruding portion of the lens barrel is connected to the first surface of the circuit board via a first adhesive (first adhesive 44a),
the second protruding portion of the lens barrel is connected to the first surface of the circuit board via a second adhesive (second adhesive 44b), and
the third protruding portion of the lens barrel is connected to the first surface of the circuit board via a third adhesive (third adhesive 44c).

Accordingly, the circuit board can support the lens barrel via the protruding portion.

(C3) The vehicular camera according to (C2), in which
at least a part of the first connection portion of the conductive wire portion is disposed between the first protruding portion and the second protruding portion.

Accordingly, it is possible to prevent interference between the conductive wire portion and the first and second protruding portions.

(C4) The vehicular camera according to (C1), in which
at least a part of the first connection portion of the conductive wire portion is disposed along the direction of the optical axis in the lens barrel.

Accordingly, it is possible to suppress an increase in the length of the first connection portion of the conductive wire portion.

(C5) The vehicular camera according to (C1), in which
the intermediate portion of the conductive wire portion faces a midpoint of the first edge of the first end surface of the circuit board in a length direction.

Accordingly, since the intermediate portion of the conductive wire portion is disposed to face the midpoint of the first edge of the circuit board, it is possible to suppress an increase in the length of the conductive wire portion.

(C6) The vehicular camera according to (C1), in which
the second connection portion of the conductive wire portion is disposed along the straight line intersecting the optical axis.

Accordingly, it is possible to suppress an increase in the length of the second connection portion of the conductive wire portion.

(C7) The vehicular camera according to (C1), in which
the connector connection portion is disposed at the center of the second surface of the circuit board.

Accordingly, the connector can be connected to the center of the circuit board.

(C8) The vehicular camera according to (C1), in which
the first shape of the circuit board further has a second edge (second edge 41b), a third edge (third edge 41c), and a fourth edge (fourth edge 41d), and
the end surface of the circuit board further includes
   a second end surface (second end surface 40c2) on the second edge,
   a third end surface (third end surface 40c3) on the third edge, and
   a fourth end surface (fourth end surface 40c4) on the fourth edge.

Accordingly, the circuit board can be easily formed.

(C9) The vehicular camera according to (C8), in which
the first shape of the circuit board is a first quadrangular shape.

Accordingly, the circuit board can be easily formed.

(C10) The vehicular camera according to (C1), in which
the second end portion of the first cylindrical shape of the lens barrel has a second shape in the plan view of the lens barrel, and
the second shape is a quadrangular shape.

Accordingly, the second end portion of the lens barrel can be easily formed.

(C11) The vehicular camera according to (C1), further including:
a switch disposed on the second surface of the circuit board, electrically connected to the connector connection portion and the conductive wire connection portion, and configured to increase or decrease a voltage and/or current to be supplied to the heater portion.

Accordingly, depending on the use situation of the vehicular camera, the state of the switch can be switched to supply different power to the heater portion, thereby changing the output of the heater portion.

(C12) The vehicular camera according to (C1), in which
the at least one lens of the lens barrel includes a plurality of lenses, and
the heater portion is able to heat a lens farthest from the imaging element among the plurality of lenses.

Accordingly, the field of view can be efficiently secured.

(C13) The vehicular camera according to (C1), in which
when the vehicular camera is disposed in a vehicle, the second connector end portion of the connector is electrically connected to the wire of the vehicle.

Accordingly, the electric power from the vehicle can be secured.

(C14) The vehicular camera according to (C1), in which
the conductive wire portion is a flexible printed circuit board.

Accordingly, the conductive wire portion can be easily formed.

(C15) The vehicular camera according to (C1), in which
the heater portion is a positive temperature coefficient (PTC) heater.

Accordingly, power consumption can be reduced.

(C16) The vehicular camera according to (C1), in which
the connector is a coaxial connector.

Accordingly, the connector can supply both the electric power and the signal.

Although the embodiment has been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely within a range without departing from the gist of the disclosure.

The present application is based on Japanese patent application (Japanese Patent

Application No. 2023-221717) filed on Dec. 27, 2023, Japanese patent application (Japanese Patent Application No. 2024-035752) filed on Mar. 8, 2024, and Japanese patent application (Japanese Patent Application No. 2024-218774) filed on Dec. 13, 2024, and the contents of which are incorporated herein by reference.

### INDUSTRIAL APPLICABILITY

The present disclosure is useful for a vehicular camera that can reduce electric power loss due to wiring resistance and suppress power consumption.

What is claimed is:

1. A vehicular camera comprising:
a lens barrel having a first cylindrical portion along an optical axis, a first end portion a second end portion opposite to the first end portion, and at least one lens disposed along the optical axis;
an imaging element disposed on the optical axis and closer to the second end portion than to the first end portion of the lens barrel;
a circuit board including a first surface, a second surface opposite to the first surface, and an end surface connecting the first surface to the second surface, the imaging element being disposed on the first surface;
a housing accommodating at least the imaging element and the circuit board, the housing having a second cylindrical portion, a third end portion, a fourth end portion disposed farther away from the first end portion of the lens barrel than the third end portion, an inner surface, and an outer surface;
a connector that outputs an image signal from the imaging element to the outside, having at least a part disposed on the fourth end portion of the housing, including a first connector end portion and a second connector end portion opposite to the first connector end portion, the first connector end portion being electrically connected to the circuit board;
a connector connection portion that is disposed on the circuit board and to which the first connector end portion of the connector is connected;
a heater portion disposed at the first end portion of the lens barrel and configured to heat the at least one lens;
a conductive wire portion having one end portion connected to the heater portion and another end portion opposite to the one end portion;
a conductive wire connection portion that is disposed on the circuit board, to which the other end portion of the conductive wire portion is connected, and that is electrically connected to the connector connection portion and the conductive wire portion; and
a switch disposed on the circuit board, electrically connected to the connector connection portion and the conductive wire connection portion, and configured to increase or decrease a voltage or current to be supplied to the heater portion, wherein
the connector connection portion, the switch, and the conductive wire connection portion are disposed on the second surface of the circuit board opposite to the first surface on which the imaging element is disposed,
the conductive wire portion has an intermediate portion between the one end portion and the other end portion,
the intermediate portion of the conductive wire portion extends from the one end portion connected to the heater portion toward the first surface of the circuit board, and passes between the end surface of the circuit board and the inner surface of the housing,
the conductive wire portion includes a first conductive wire and a second conductive wire, and
the conductive wire portion supplies predetermined electric power to the heater portion via the connector, the connector connection portion, the switch, the conductive wire connection portion, and the first conductive wire and the second conductive wire of the conductive wire portion.

2. The vehicular camera according to claim 1, wherein
the first conductive wire of the conductive wire portion, the heater portion, and the second conductive wire of the conductive wire portion constitute a part of a closed circuit.

3. The vehicular camera according to claim 1, wherein
the intermediate portion of the conductive wire portion extends from the one end portion connected to the heater portion through an inside of the lens barrel toward the first surface of the circuit board, and passes between the end surface of the circuit board and the inner surface of the housing.

4. The vehicular camera according to claim 3, further comprising:
a shield portion surrounding the circuit board, wherein
a part of the shield portion is disposed between the inner surface of the housing and the end surface of the circuit board, and
the part of the shield portion is disposed between the inner surface of the housing and the intermediate portion of the conductive wire portion.

5. The vehicular camera according to claim 1, wherein
in a case that the switch is in a first state, a first electric power is supplied from the switch to the heater portion, and
in a case that the switch is in a second state, a second electric power smaller than the first electric power is supplied from the switch to the heater portion.

6. The vehicular camera according to claim 1, wherein
the connector is a coaxial connector,
the vehicular camera further comprises a filter circuit electrically connected to the connector connection portion and the switch and configured to separate a part of third electric power supplied from the connector and electric power of the image signal output from the imaging element, and
the filter circuit is disposed on the second surface of the circuit board opposite to the first surface where the imaging element is disposed.

7. The vehicular camera according to claim 6, wherein
the part of the third electric power is supplied to the switch via the filter circuit.

8. The vehicular camera according to claim 7, wherein
on the second surface of the circuit board opposite to the first surface on which the imaging element is disposed, a first distance between a center of the filter circuit and a center of the connector connection portion is shorter than a second distance between the center of the filter circuit and a center of the switch.

9. The vehicular camera according to claim 6, further comprising:
a serializer disposed on the first surface or the second surface of the circuit board and electrically connected to the connector connection portion and the imaging element, wherein
the image signal output from the imaging element is a parallel signal, and
the serializer converts the parallel signal into a serial signal and outputs the serial signal to the connector.

10. The vehicular camera according to claim 9, wherein
the serializer is disposed on the second surface of the circuit board.

11. The vehicular camera according to claim 5, further comprising:
a switch control circuit on the first surface or the second surface of the circuit board, wherein
the switch control circuit outputs a control signal for switching between the first state and the second state to the switch.

12. The vehicular camera according to claim 11, wherein
the control signal is output from an electronic control unit (ECU) mounted on a vehicle, and is input into the switch control circuit via the connector.

13. The vehicular camera according to claim 6, wherein
a ratio of the predetermined electric power supplied to the heater portion to fourth electric power obtained by subtracting the predetermined electric power from the third electric power is in a range of 1:2 to 2:1.

14. The vehicular camera according to claim 9, further comprising:
a power supply integrated circuit (IC) disposed on the first surface or the second surface of the circuit board and electrically connected to the filter circuit, the imaging element, and the serializer, wherein
a part of the third electric power supplied from the connector is supplied to the power supply IC via the filter circuit, and then is supplied from the power supply IC to the imaging element and the serializer.

15. The vehicular camera according to claim 14, wherein
the power supply IC is disposed on the second surface of the circuit board.

16. The vehicular camera according to claim 1, wherein
the second cylindrical portion of the housing has a first side wall portion, a second side wall portion, a third side wall portion, and a fourth side wall portion,
the circuit board has, in the plan view of the second surface of the circuit board, a first edge portion corresponding to the first side wall portion, a second edge portion corresponding to the second side wall portion, a third edge portion corresponding to the third side wall portion, and a fourth edge portion corresponding to the fourth side wall portion,
at least a part of the intermediate portion of the conductive wire portion is between the first side wall portion of the second cylindrical portion of the housing and the first edge portion of the circuit board,
the connector connection portion is disposed at a center portion of the second surface of the circuit board in the second surface of the circuit board, and
the conductive wire connection portion is disposed between the connector connection portion and the first edge portion of the circuit board in the second surface of the circuit board.

17. The vehicular camera according to claim 1, wherein
the at least one lens of the lens barrel includes a plurality of lenses, and
the heater portion is able to heat a lens farthest from the imaging element among the plurality of lenses.

18. The vehicular camera according to claim 17, wherein
the lens barrel further includes, at the second end portion, a flange portion extending in a direction away from the optical axis over an entire circumference around the optical axis, and
the third end portion of the housing is connected to the flange portion of the lens barrel.

19. The vehicular camera according to claim 1, wherein
in a case that the vehicular camera is disposed in a vehicle, the second connector end portion of the connector is electrically connected to the wire of the vehicle.

20. The vehicular camera according to claim 1, wherein
the conductive wire portion is a flexible printed circuit board.
